(19) United States
(12) Patent Application Publication
(10) Pub. No.: US 2023/0221541 A1
(43) Pub. Date: Jul. 13, 2023

(54) SYSTEMS AND METHODS FOR MULTIVIEW SUPER-RESOLUTION MICROSCOPY

(71) Applicant: THE UNITED STATES OF AMERICA, AS REPRESENTED BY THE SECRETARY, DEPARTMENT OF HEALTH AND HUMAN SERVIC, Bethesda, MD (US)

(72) Inventors: Hari Shroff, Ashburn, VA (US); Patrick La Riviere, Chicago, IL (US); Yicong Wu, Bethesda, MD (US); Xiaofei Han, Beijing (CN)

(21) Appl. No.: 17/995,271

(22) PCT Filed: Mar. 26, 2021
(86) PCT No.: PCT/US2021/024512

§ 371 Date: Sep. 30, 2022

Related U.S. Application Data
(60) Provisional application No. 63/001,691, filed on Mar. 30, 2020.
(60) Provisional application No. 63/001,672, filed on Mar. 30, 2020.

(51) Int. Cl. G02B 21/36; G02B 21/00; G01N 21/64

(52) U.S. Cl. CPC G02B 21/367; G02B 21/0076; G01N 21/6458

(57) ABSTRACT

Methods and systems are provided for improving resolution, acquisition speed, and/or illumination dose for microscopy systems. In some embodiments, a microscopy system having multiple objective setups may include illumination generators to provide selectively-blanked illumination line scans, objective lenses to introduce the selectively-blanked illumination line scans to a sample and to collect fluorescence emissions from the sample, and detectors to receive the fluorescence emissions from the objective lenses. The microscopy system may also include one or more processors in operative communication with the detectors, which may combine the fluorescence emissions to generate a composite image.

### CROSS-REFERENCE TO RELATED APPLICATIONS

The present application claims priority to U.S. Provisional Application 63/001,691, entitled “SYSTEMS AND METHODS FOR MULTIVIEW SUPER-RESOLUTION MICROSCOPY,” and filed on Mar. 30, 2020, and to U.S. Provisional Application 63/001,672, entitled “SYSTEMS AND METHODS FOR OPTICAL REASSIGNMENT IN MULTIVIEW SUPER-RESOLUTION MICROSCOPY,” and filed on Mar. 30, 2020. The entirety of the above-listed applications are hereby incorporated by reference for all purposes.

### FIELD

The disclosure relates to super-resolution microscopy, and in particular to improvements in multiview super-resolution structured illumination microscopy (SIM) systems and methods.

### BACKGROUND AND SUMMARY

The resolution of fluorescence microscopy is limited to about 250 nanometers (nm) laterally and about 500 nm to 700 nm axially. Since the length-scales of protein assemblies and subcellular structures extend down to the nm scale and are usually obscured by diffraction, improvements to spatial resolution may be highly valuable to biological imaging. Structured illumination microscopy (SIM) Techniques may offer improved resolution while retaining the ability to image living cells and tissue.

The systems and methods described and depicted herein overcome various performance limitations to super-resolution microscopy. By combining multiview imaging (which synthesizes complementary information from different views of a sample) with sharp illumination structure, improvements may be made to the depth, resolution, and speed of conventional single-objective three-dimensional (3D) SIM. By using sharp, diffraction-limited lateral illumination structures to excite a sample from each of three views (or, in some embodiments, another plurality of views), laterally super-resolved volumes may advantageously be obtained and combined to generate a reconstructed volume of the sample that combines the best resolution from each view of the sample. Lateral spatial frequencies introduced even at moderately low numerical aperture (NA) may also be higher than the highest axial spatial frequency achieved in conventional single-objective 3D SIM at high NA. As a result, an overall-volume resolution of the reconstruction (and especially an axial resolution of the reconstruction) may advantageously be significantly better than conventional 3D SIM.

Disclosed herein are methods and systems for improving the performance of 3D SIM, a popular and proven technique for doubling the resolution of conventional fluorescence microscopy. In various embodiments, the methods and systems disclosed herein may advantageously offer better depth penetration than conventional 3D SIM, which may extend super-resolution performance into thicker samples (e.g., tens of microns (μm) thick instead of less than 10 μm thick). In comparison with conventional 3D SIM, the methods and systems may also advantageously improve axial resolution two-fold, increase acquisition speed by three-fold (or more), and lower illumination dose by similar factors. Greater improvements to these performance metrics may be possible if the lenses used have higher NA.

Also disclosed herein are methods and systems for improving multiview super-resolution microscopy that employ an optical reassignment strategy for providing real-time super-resolution imaging in which fluorescence emitted from a sample is collected in epi-mode, descanned, pinholed, and then rescanned before imaging onto a camera for detection. In various embodiments, machine learning may be utilized to enable collection of multiple raw volumetric views of the sample and to employ physics-based reconstructions. Machine learning may also be used to improve super-resolution prediction.

In some embodiments, the issues described above may be addressed by multiview super resolution microscopy systems comprising a plurality of objective setups (or “arms”). The objective setups may include illumination generators, objective lenses, and detectors (among other components). The illumination generators may provide selectively-blanked illumination line scans. The objective lenses may introduce the selectively-blanked illumination line scans to a sample and may collect fluorescence emissions from the sample. The detectors may then receive the fluorescence emissions from the objective lenses. The first objective lens may be oriented along a first directional axis, and the second objective lens may be oriented along a second directional axis oblique to the first directional axis. The microscopy systems may also comprise one or more processors in operative communication with the detectors, which may combine the fluorescence emissions to generate a composite image.

For some embodiments, the issues described above may be addressed by methods of multiview super-resolution microscopy. The methods may include, for a plurality of objective setups: providing selectively-blanked illumination line scans; introducing the selectively-blanked illumination line scans to a sample through objective lenses; collecting fluorescence emissions from the sample through the objective lenses; receiving the fluorescence emissions at detectors; and combining the fluorescence emissions to generate a composite image. When the plurality of objective setups includes at least two objective setups, the objective lens for the first objective setup may be oriented toward the sample from a first direction, and the objective lens for the second objective setup may be oriented to the sample from a second direction at an obtuse angle to the first direction.

In some embodiments, the issues described above may be addressed by multiview super resolution microscopy systems comprising an objective setup that includes a two-dimensional (2D) excitation scanner, an objective lens, a 2D descanner, an adjustable pinhole, a 2D rescanner, and a detector. The 2D excitation scanner may provide a scanned laser beam, and the objective lens may introduce the scanned laser beam to a sample and collect a fluorescence emission from the sample. The 2D descanner may descan the fluorescence emission, the adjustable pinhole may remove out-of-focus emissions from the descanned fluorescence emission, the 2D rescanner may rescan the descanned fluorescence emission that passes through the adjustable pinhole, and the detector may receive the rescanned fluorescence emission. One or more processors in operative communication with the detector may then generate an image based upon at least the rescanned fluorescence emission.

For some embodiments, the issues described above may be addressed by methods of multiview super-resolution microscopy. The methods may include: providing scanned laser beams; introducing the scanned laser beams to a sample through objective lenses; collecting fluorescence emissions from the sample through the objective lenses; descanning the fluorescence emissions; removing out-of-focus fluorescence emissions from the descanned fluorescence emissions; rescanning the descanned fluorescence emissions from which out-of-focus emissions have been removed; and generating an image based upon at least the rescanned fluorescence emission.

In some embodiments, the issues described above may be addressed by methods that may include: providing first microscopy images derived from sharp structured illumination to a neural network at various angles of rotation; generating, for each of the plurality of angles of rotation, respectively-corresponding second microscopy images based upon the first microscopy images and super-resolved in a single dimension along an axis set by the angles of rotation; and combining the second microscopy images into a third microscopy image. The third microscopy image may be super-resolved in a plurality of directions respectively corresponding with plurality of angles of rotation.

For some embodiments, the issues described above may be addressed by methods of producing super-resolution microscopy images with isotropic resolution which may include: providing microscopy images derived from sharp structured illumination to a neural network at each of a plurality of rotations; generating pluralities of single-dimension enhanced-resolution microscopy images respectively corresponding with the plurality of rotations; and combining the pluralities of single-dimension enhanced-resolution microscopy images by joint deconvolution into super-resolved microscopy images with isotropic resolution.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 is a schematic illustration of a multiview SIM system, in accordance with one or more embodiments of the present disclosure;

FIG. 2 provides schematic illustrations of lateral resolution pertaining to line scanning, in accordance with one or more embodiments of the present disclosure;

FIG. 3 is a schematic illustration of a multiview line-scanning configuration for enhanced resolution, in accordance with one or more embodiments of the present disclosure;

FIGS. 4A-4D illustrate axial optical transfer functions (OTFs) and lateral OTFs for various microscopy systems along coordinates defined in FIG. 3, in accordance with one or more embodiments of the present disclosure;

FIG. 5 is a schematic illustration of portions of a microscopy system incorporating structures for optical reassignment, in accordance with one or more embodiments of the present disclosure;

FIG. 6 is a schematic illustration of a system for using machine learning to obtain super-resolution data, in accordance with one or more embodiments of the present disclosure;

FIG. 7 shows a schematic illustration of paired diffraction-limited images and one-dimensional (1D) super-resolved images, in accordance with one or more embodiments of the present disclosure;

FIG. 8 shows a schematic illustration of the use of neural networks to predict 1D super-resolved images based on the paired images of FIG. 7, in accordance with one or more embodiments of the present disclosure;

FIG. 9 shows images related to the use of the neural networks of FIG. 8, in accordance with one or more embodiments of the present disclosure;

FIGS. 10A and 10B show schematic illustrations of the use of neural networks trained to predict 1D super-resolved images to produce predicted isotropic super-resolved images, in accordance with one or more embodiments of the present disclosure;

FIGS. 11A and 11B show images related to the use of the neural networks of FIGS. 10A and 10B, in accordance with one or more embodiments of the present disclosure;

FIGS. 12A and 12B show a flow diagram of a method for performing multiview SIM, in accordance with one or more embodiments of the present disclosure;

FIG. 13 shows a flow diagram of a method for incorporating optical reassignment into microscopy, in accordance with one or more embodiments of the present disclosure; and

FIGS. 14 and 15 show methods for producing isotropic super-resolved images, in accordance with one or more embodiments of the present disclosure.

### DETAILED DESCRIPTION

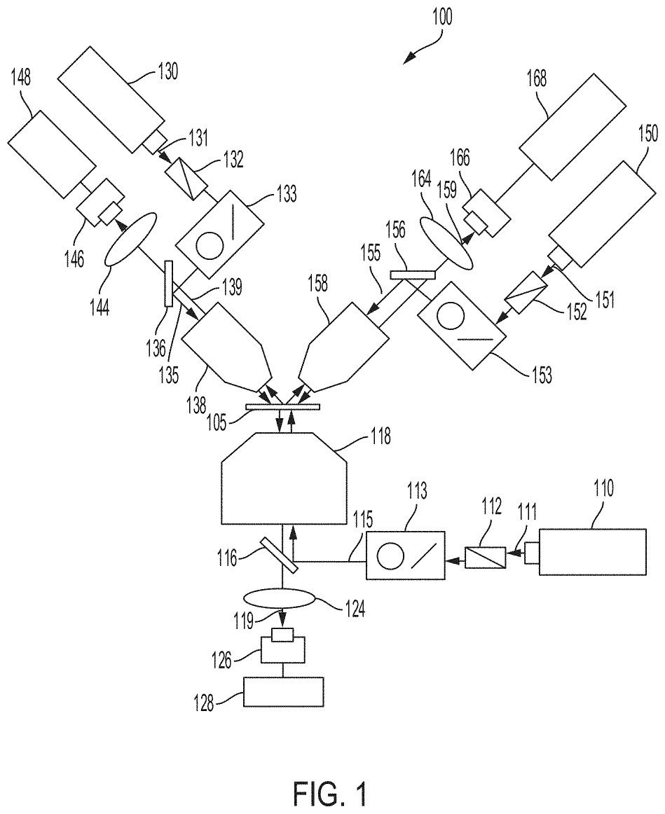

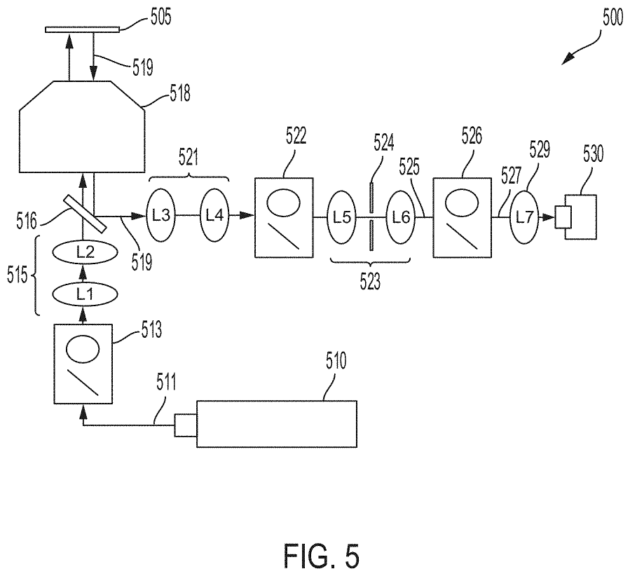

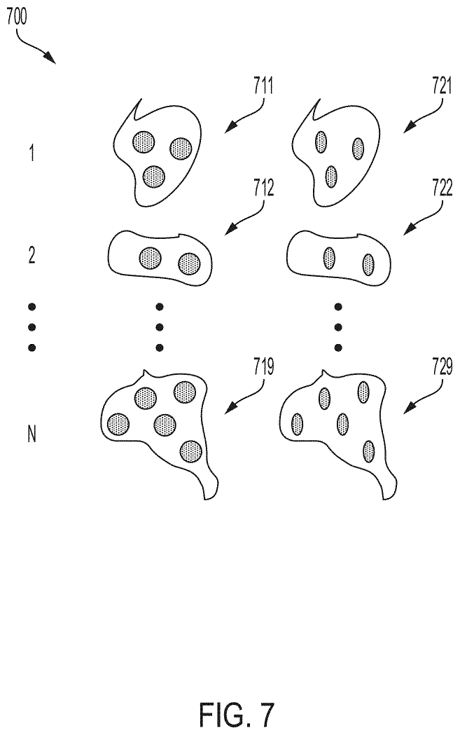

Disclosed herein are systems and methods for improving structured illumination microscopy (SIM). FIGS. 1 through 4D, 12A, and 12B pertain to multi-view microscopy setups for which sharp, structured illumination introduced to each view is periodically blanked, such as with fast shutters. FIGS. 5, 6, and 13 pertain to microscopy systems employing optical reassignment strategies. FIGS. 7-11B, 14, and 15 pertain to machine-learning-based improvements to microscopy systems.

As used herein, terminology in which “an embodiment,” “some embodiments,” or “various embodiments” are referenced signify that the associated features, structures, or characteristics being described are in at least some embodiments, but are not necessarily in all embodiments. Moreover, the various appearances of such terminology do not necessarily all refer to the same embodiments. As used in this application, an element or step recited in the singular and proceeded with the word “a” or “an” should be understood as not excluding plural of said elements or steps, unless such exclusion is stated. Terms such as “first,” “second,” “third,” and so on are used merely as labels, and are not intended to impose numerical requirements or a particular positional order on their objects. Also, terminology in which elements are presented in a list using “and/or” language means any combination of the listed elements. For example, “A, B, and/or C” may mean any of the following: A alone; B alone; C alone; A and B; A and C; B and C; or A, B, and C.

One representation of the systems and methods disclosed herein pertains to the use of multiview SIM systems for super-resolution microscopy. FIG. 1 schematically illustrates a microscopy system 100 for providing multiview super-resolution microscopy. Microscopy system 100 has three “arms” for illuminating a sample, e.g., in accordance with a triple-view objective setup (although some embodiments may employ other numbers of arms). Microscopy system 100 may enable multiview imaging (e.g., combining complementary information from different views of a sample) in combination with a sharp illumination structure, which may advantageously improve the depth, resolution, and/or speed of single-objective (3D) SIM systems. Microscopy system 100 may use sharp line-focused illumination structures to excite and confocally detect fluorescence emitted by the sample from three complimentary views. Since resolution along any particular directional axis may be defined by the super-resolved lateral resolution improvement obtained via that particular axis, axial resolution may be improved greater than two-fold by microscopy system 100 over conventional microscopy systems, such as conventional 3D SIM.

A triple-view objective setup such as microscopy system 100 may have arms each of which is capable of introducing sharp structured illumination to a sample, but from different angles. Illumination may be sharply focused and scanned at a sample via a generator/scanner unit, which could include a cylindrical lens and/or a two-dimensional (2D) galvanometric assembly for generating sharp line illumination and scanning it at a sample plane. A high-speed shutter (e.g., an acousto-optic tunable filter) may be used to blank lines as it scans, which may introduce sparse structured illumination at the sample. Fluorescence from each view may then be collected in epi-mode from each objective and separated from the laser illumination via a dichroic mirror before being collected by a tube lens and focused onto an area detector like a camera.

Accordingly, microscopy system 100 includes a first objective 118 configured in an inverted position beneath sample 105. Microscopy system 100 also includes additional objectives configured in positions above sample 105, thereby filling a remaining solid angle above a coverslip (not shown) on which sample 105 is deposited for observation, such as a second objective 138 and a third objective 158. In some embodiments, microscopy system 100 may include a plurality of additional objectives configured in positions above sample 105. As discussed herein, each of first objective 118, second objective 138, and third objective 158 (along with sets of other components that correspond with objectives 118, 138, and 158) may pertain to an arm of microscopy system 100.

First objective 118 may comprise a relatively high NA lens (e.g., a 1.2 NA lens, such as a 1.2 NA water immersion lens). In comparison, second objective 138 and third objective 158 may relatively lower-resolution lenses (e.g., 0.8 NA lenses, such as 0.8 NA water immersion lenses).

In a first arm of microscopy system 100, first objective 118 is in operative association with a first illumination source 110 (which may include a laser), which transmits a first single laser beam 111 through a first fast shutter 112, then through a first sharp illumination generator and scanner 113, to generate a sharp first illumination line scan 115. In some embodiments, first fast shutter 112 may selectively blank first single laser beam 111 in providing first illumination line scan 115 to first sharp illumination generator and scanner 113, thereby providing a sparse structured illumination for sample 105.

For some embodiments, first sharp illumination generator and scanner 113 may include a cylindrical lens and/or a 2D galvanometric assembly. In some embodiments, first fast shutter 112 may include an acousto-optic tunable filter, a fast polarization-sensitive shutter (e.g., based on a liquid crystal device), a fast shutter provided within a head of first illumination source 110, and/or a fast mechanical shutter.

Following first sharp illumination generator and scanner 113, a first dichroic mirror 116 provides first illumination line scan 115 to first objective 118 (e.g., by reflection). First illumination line scan 115 is then transmitted through first objective 118, which focuses first illumination line scan 115 (e.g., through an underside of sample 105) for use in illuminating and scanning sample 105 along from a first angle of incidence along a first directional axis.

For some embodiments, the first arm may include further illumination optics (e.g., one or more intermediate tube lenses between first sharp illumination generator and scanner 113 and first objective 118) that serve to image first sharp illumination generator and scanner 113 to a back focal plane of first objective 118.

Once sample 105 is illuminated from the first angle of incidence, first fluorescence emissions 119 emitted by sample 105 back along the first directional axis are collected (e.g., in epi-mode) through first objective 118, and are thereafter separated from first illumination line scan 115 via first dichroic mirror 116. A first tube lens 124 then collects and focuses first fluorescence emissions 119 onto a first detector 126, which may provide images to a first processor 128.

In some embodiments, the first arm may include an emission filter (not shown) positioned before first detector 126. For some embodiments, first detector 126 may comprise a camera or other imaging device (e.g., a camera chip). In various embodiments, first detector 126 may operate in a “rolling shutter mode” which may be synchronized with first illumination line scan 115 to filter out out-of-focus first fluorescence emissions 119, and thereby improve depth performance. For some embodiments, first processor 128 may combine a plurality of images from first detector 126 (e.g., sparse, diffraction-limited images, which may be made using first fast shutter 112) into a super-resolution image.

In addition, similar arrangements may be employed related to second objective 138 and third objective 158, to additionally illuminate sample 105 at different angles of incidence through a topside of sample 105, then collect resulting fluorescence emissions epi-mode from different angles relative to the collection of first fluorescence emissions 119 through first objective 118.

Accordingly, in a second arm of microscopy system 100, second objective 138 is in operative association with a second illumination source 130 (which may include a laser), which transmits a second single laser beam 131 through a second fast shutter 132, then through a second sharp illumination generator and scanner 133, to generate a sharp second illumination line scan 135. In some embodiments, second fast shutter 132 may selectively blank second single laser beam 131 in providing second illumination line scan 135 to second sharp illumination generator and scanner 133, thereby providing a sparse structured illumination for sample 105.

For some embodiments, second sharp illumination generator and scanner 133 may include a cylindrical lens and/or a 2D galvanometric assembly. In some embodiments, second fast shutter 132 may include an acousto-optic tunable filter, a fast polarization-sensitive shutter (e.g., based on a liquid crystal device), a fast shutter provided within a head of second illumination source 130, and/or a fast mechanical shutter.

Following second sharp illumination generator and scanner 133, a second dichroic mirror 136 provides second illumination line scan 135 to second objective (e.g., by reflection). Second illumination line scan 135 is then transmitted through second objective 138, which focuses second illumination line scan 135 (e.g., through the topside of sample 105) for use in illuminating and scanning sample 105 from a second angle of incidence along a second directional axis.

For some embodiments, the second arm may include further illumination optics (e.g., one or more intermediate tube lenses between second sharp illumination generator and scanner 133 and second objective 138) that serve to image second sharp illumination generator and scanner 133 to a back focal plane of second objective 138.

Once sample 105 is illuminated from the second angle of incidence, second fluorescence emissions 139 emitted by sample 105 back along the second directional axis are collected (e.g., in epi-mode) through second objective 138, and are thereafter separated from second illumination line scan 135 via second dichroic mirror 136. A second tube lens 144 then collects and focuses second fluorescence emissions 139 onto a second detector 146, which may provide images to a second processor 148.

In some embodiments, the second arm may include an emission filter (not shown) positioned before second detector 146. For some embodiments, second detector 146 may comprise a camera or other imaging device. In various embodiments, second detector 146 may operate in a “rolling shutter mode” which may be synchronized with second illumination line scan 135 to filter out out-of-focus second fluorescence emissions 139, and thereby improve depth performance. For some embodiments, second processor 148 may combine a plurality of images from second detector 146 (e.g., sparse, diffraction-limited images, which may be made using second fast shutter 132) into a super-resolution image.

Similarly, in a third arm of microscopy system 100, third objective 158 is in operative association with a third illumination source 150 (which may include a laser), which transmits a third single laser beam 151 through a third fast shutter 152, then through a third sharp illumination generator and scanner 153, to generate a sharp third illumination line scan 155. In some embodiments, third fast shutter 152 may selectively blank third single laser beam 151 in providing third illumination line scan 155 to third sharp illumination generator and scanner 153, thereby providing a sparse structured illumination for sample 105.

For some embodiments, third sharp illumination generator and scanner 153 may include a cylindrical lens and/or a 2D galvanometric assembly. In some embodiments, third fast shutter 152 may include an acousto-optic tunable filter, a fast polarization-sensitive shutter (e.g., based on a liquid crystal device), a fast shutter provided within a head of third illumination source 150, and/or a fast mechanical shutter.

Following third sharp illumination generator and scanner 153, a third dichroic mirror 156 provides third illumination line scan 155 to third objective 158 (e.g., by reflection). Third illumination line scan 155 is then transmitted through third objective 158, which focuses third illumination line scan 155 (e.g., through the topside of sample 105) for use in illuminating and scanning sample 105 from a third angle of incidence along a third directional axis.

For some embodiments, the third arm may include further illumination optics (e.g., one or more intermediate tube lenses between third sharp illumination generator and scanner 153 and third objective 158) that serve to image third sharp illumination generator and scanner 153 to a back focal plane of third objective 158.

Once sample 105 is illuminated from the third angle of incidence, third fluorescence emissions 159 emitted by sample 105 back along the third directional axis are collected (e.g., in epi-mode) through third objective 158, and are thereafter separated from third illumination line scan 155 via third dichroic mirror 156. A third tube lens 164 then collects and focuses third fluorescence emissions 159 onto a third detector 166, which may provide images to a third process 168.

In some embodiments, the third arm may include an emission filter (not shown) positioned before third detector 166. For some embodiments, third detector 166 may comprise a camera or other imaging device. In various embodiments, third detector 166 may operate in a “rolling shutter mode” which may be synchronized with third illumination line scan 155 to filter out out-of-focus third fluorescence emissions 159, and thereby improve depth performance. For some embodiments, third processor 168 may combine a plurality of images from third detector 166 (e.g., sparse, diffraction-limited images, which may be made using third fast shutter 152) into a super-resolution image.

In various embodiments, an illumination choice in one or more of the three arms may be a line focus generator one-dimensional (1D) scanner, which may be achieved by scanning a line focus produced by a cylindrical lens. If each of the detectors (e.g., cameras) of the three arms is equipped with a “rolling shutter” that is then synchronized with the line scan, out-of-focus emissions from a sample may advantageously be minimized, enabling or facilitating a ten-fold or greater increase in sample thickness compared to conventional 3D SIM (which may be based on an epi-fluorescence microscope and may thus be very prone to contamination from out-of-focus emissions).

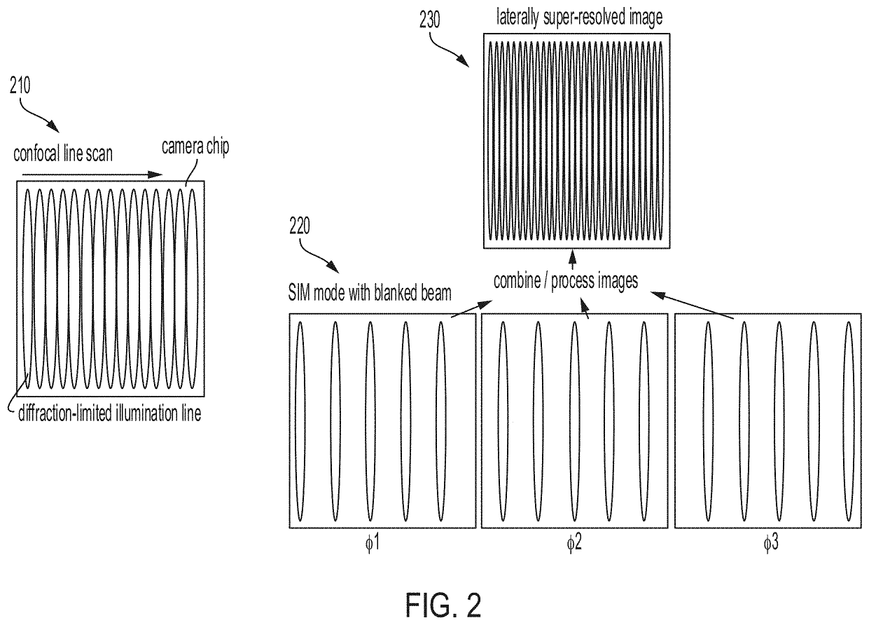

FIG. 2 provides schematic illustrations of lateral resolution pertaining to line scanning. In a scenario 210, a view (e.g., objectives 118, 138, and/or 158) may acquire an imaging volume as the corresponding line is scanned through sample 105, such as by taking one image for each line-scan and then repeating this procedure for multiple planes through sample 105 in order to obtain three optically sectioned volumetric views of sample 105. If a line is scanned horizontally from left to right, synchronously with a rolling-shutter pixel line readout of one of detectors 126, 146, and/or 166 (one or more of which may include a camera), an optically-sectioned image results, but the resulting image will remain diffraction-limited.

In various embodiments, a plurality of optically volumetric views (e.g., three views) may be registered and combined with deconvolution in a manner analogous to multi-view light sheet microscopy. In this scenario, the resolution of the final reconstruction image may then combine the best lateral resolution of each of the optically sectioned volumetric views, thereby generating a better volume resolution than any of the individual raw volumes alone. Accordingly, the capability to shutter or otherwise blank single laser beams 111, 131, and/or 151 implies that illumination patterns resulting from illumination line scans 115, 135, and/or 155 can be made sparse, which may advantageously facilitate super-resolution imaging. For example, by appropriately blanking single laser beams 111, 131, and 151, periodic, sparse and sharp illumination patterns at different phase shifts may be generated. Thus, if fast shutters 112, 132, and/or 152 are used to blank single laser beams 111, 131, and/or 151, sparse periodic illumination patterns may result.

A series of such images may thus be taken at different phase shifts. For example, as depicted in a scenario 220, a series of three images may be taken at three different phase shifts (e.g., approximately 120 degrees relative to each other). Sparse, diffraction-limited images (as depicted in scenario 220) may then be combined into a super-resolution image in which resolution may be improved by around two-fold (or more) in the direction of scan (as depicted in a scenario 230).

In various embodiments of microscopy system 100, each of the views taken at a different angle relative to sample 105 may acquire an imaging volume as illumination line scans 115, 135, and 155 are scanned through the sample 105 (e.g., taking one image and repeating this process for each phase shift).

If each of the views acquires an imaging volume as the line is scanned through the sample (e.g., taking one image for each line-scan, as in scenario 210), and this procedure is then repeated for multiple planes through the sample, three optically-sectioned volumetric views of the sample can be obtained, registered, and combined (e.g., with deconvolution). The resolution of the final reconstruction may combine the best lateral resolution of each of the three views, offering a better volume resolution than any of the individual raw volumes. However, the capability to rapidly shutter the beam implies that the illumination can be made sparse, which may advantageously enable super-resolution imaging. Appropriate blanking of the illumination at different phase shifts may enable periodic, sparse, sharp illumination. By taking a series of such images at different phase shifts (e.g., the three images of scenario 220), and by processing them appropriately, spatial resolution may be improved approximately two-fold in the direction of each line scan (e.g., as in scenario 230). By combining all images from all three views (such as by appropriately registering and deconvolving them), volume resolution may be improved eight-fold or more relative to the conventional confocal line scan mode.

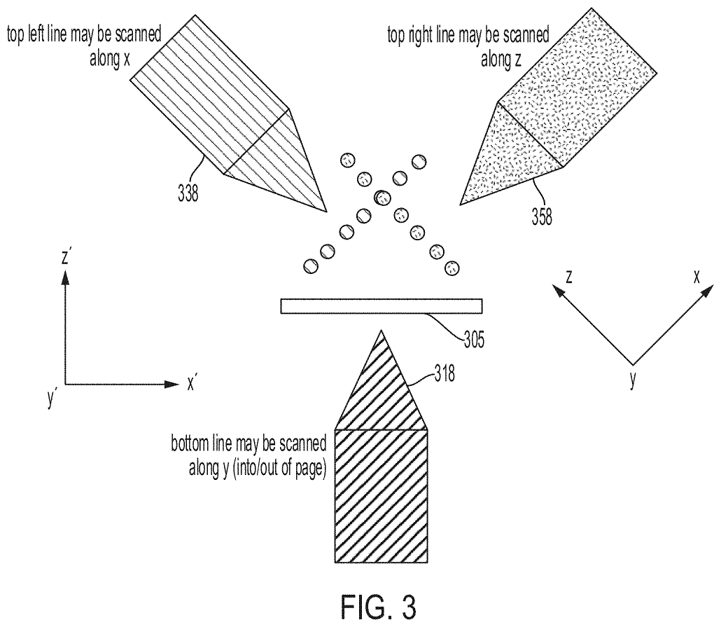

FIG. 3 is a schematic illustration of a multiview line-scanning configuration for enhanced resolution. In various embodiments, a first objective 318, a second objective 138, and a third objective 158 may scan a sample 305 in different directions (e.g., along different axes of a coordinate system).

For microscopy systems having the capability to generate super-resolution images in each lateral direction (such as microscopy system 100), various embodiments of disclosed herein may employ an acquisition scheme in which each of the line scans produced by first objective 318, second objective 338, and third objective 358 are scanned along a distinct and orthogonal Cartesian coordinate (e.g., as shown in the unprimed coordinates of FIG. 3). By scanning the lines in this manner, a doubling of 3D resolution relative to multiview line-scanning confocal microscopy may advantageously be achieved. In various embodiments, scanning along other axes may result in a lesser resolution improvement.

In various embodiments, the disclosed mechanisms and methods may provide better resolution enhancement than conventional 3D SIM. The resolution of an imaging system can be described by its point spread function (PSF) or alternatively, in frequency space, the Fourier transform of the PSF or optical transfer function (OTF). The larger the extent of the OTF (also called the “support” of the OTF), the better the resolution.

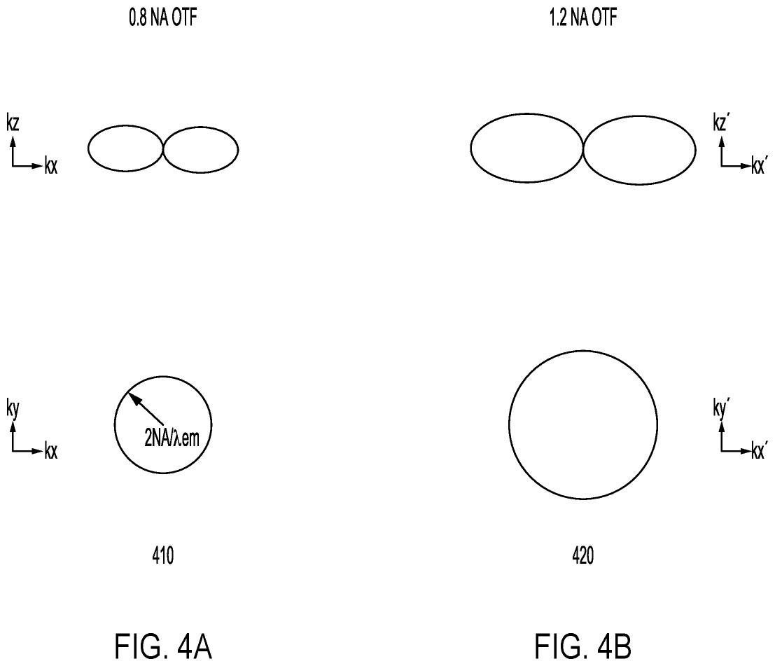

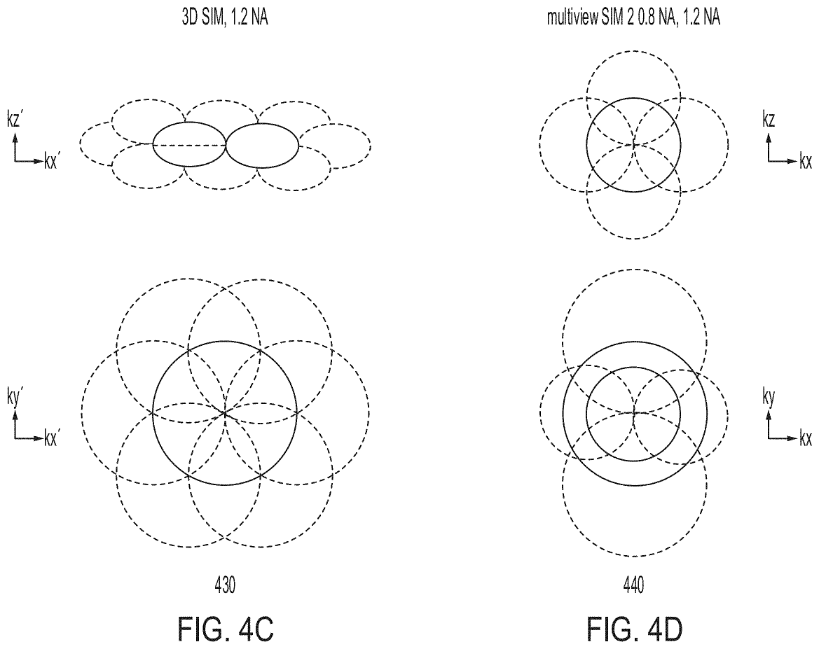

FIGS. 4A-4D illustrate axial OTFs and lateral OTFs for various microscopy systems, along primed and unprimed coordinate systems defined in FIG. 3. FIG. 4A depicts an OTF extent 410 (in x, y, and z as defined in FIG. 3) corresponding with a single view objective microscopy system employing a 0.8 NA objective lens. FIG. 4B depicts an OTF extent 420 (in x′, y′, and z′ as defined in FIG. 3) corresponding with a single view objective microscopy system employing a 1.2 NA objective lens. FIG. 4C depicts an OTF extent 430 (in x′, y′, and z′ as defined in FIG. 3) corresponding with a conventional 3D SIM system employing a 1.2 NA lens. FIG. 4D depicts an OTF extent 440 (in x, y, and z as defined in FIG. 3) corresponding with a multiview SIM system such as microscopy system 100 disclosed herein, which may employ 1.2 NA and 0.8 NA lenses.

For FIGS. 4A-4D, axial OTF extents are shown in the top and lateral OTF extents are shown in the bottom. Dashed lines shown indicate the extent of potential resolution improvement obtained after combining images and/or views.

In various conventional 3D SIM methods, fifteen images are taken per plane with sharp sinusoidal illumination that is phase shifted by five phases and rotated in three directions. The fifteen raw images are processed to provide a doubling of resolution in the z direction (e.g., as in the top of OTF extent 430) and in the xy direction (e.g., as in the bottom of OTF extent 430). However, since the extent of the OTF for any lens may be two to three times worse in the z direction than in the xy direction, the axial resolution in a 3D SIM system may be two to three times worse than the lateral resolution. Indeed, in a popular implementation of 3D SIM, spatial resolution has been reported as approximately 120 nm by 120 nm by 360 nm (xyz).

In contrast, for embodiments of multiview line-scanning SIM as in microscopy system 100, the axial resolution may be defined by a doubling in the lateral support of the 0.8 NA OTF (e.g., as in the top of OTF extent 440) as the resolution in each direction is now given by the lateral resolution enhancement provided by the line scan. Accordingly, even though a resolution enhancement along the x direction may be less than in 3D SIM (since the resolution gain is achieved via the 0.8 NA lens), the resolution gain in the z direction may more than compensate for that loss. Given the expected spatial resolution of 360 nm by 240 nm by 360 nm obtained in the non-SIM arrangement, multiview line confocal mode (e.g., in scenario 210 of FIG. 2), a final resolution of about 180 nm×120 nm×180 nm, which effectively doubles the axial resolution and provides a 30% improvement in overall volume resolution, may be expected. Further resolution enhancement may be expected if the NA of the 0.8 NA lenses are increased (e.g., to NA 1.1) which may also be commercially available.

Another advantage of the disclosed systems and methods is that such resolution enhancement may be likely obtained with fewer raw images than in conventional 3D SIM. In conventional 3D SIM, to achieve resolution of 360 nm may rely upon at least Nyquist sampling the dimension, or taking a z step no courser than 180 nm. In comparison, in microscopy system 100, each raw view may merely be sampled at about 500 nm (e.g., Nyquist sampling the relatively coarse axial extent of the PSF of each lens). This reasoning may advantageously provide a reduction in images of 500 nm to 190 nm, or about three-fold, with a concomitant reduction in dose.

Referring to FIGS. 4A-4D, as noted above, axial OTF extents are shown in the top and lateral OTF extents are shown in the bottom, for single view objectives (using a 0.8 NA lens and a 1.2 NA lens), conventional 3D SIM (using a 1.2 NA lens), and microscopy system 100 (using, e.g., two 0.8 NA lenses and one 1.2 NA lens). It should be noted that the size of the OTF extent is proportional to the NA of the objective lens. It should also be noted that the greater OTF support in the z direction results for the microscopy system 100 as compared to the conventional SIM system.

Various approaches for further improving microscopy system 100 are also contemplated herein. In some embodiments, spatial resolution may be further improved by using higher-NA objective lenses (e.g., preferably a combination of commercially-available 1.1 NA lenses and 0.71 NA lenses), which may advantageously lead to greater overall NA if such lenses are positioned above the sample, or at the “top” of the sample. For some embodiments, resolution enhancement may result if a reversibly-fluorescent dye whose fluorescent or non-fluorescent states may be “saturated,” which may advantageously excite effectively narrower regions of fluorescence in the sample. In principle, exploiting such a nonlinear fluorescent response might advantageously lead to unlimited spatial resolution (although potentially at the cost of many more raw images being obtained).

For some embodiments, an approach for improving overall resolution may include the use of a 2D line illumination pattern from the bottom, higher-NA first objective 118, so that the x direction (as shown in FIG. 3) may also benefit from the improved NA of first objective 118 (e.g., the bottom objective). If such an additional scan were performed, a resolution of images obtained by microscopy system 100 may advantageously be strictly improved relative to conventional 3D SIM.

For some embodiments, depth penetration can be improved by using longer wavelength illumination, especially in the near infrared (NIR) regime. By using a sharply focused femtosecond excitation beam (either alone or in combination with temporal focusing for providing improved optical sectioning), high speed multiphoton illumination could be provided, thereby further reducing background noise due to the nonlinear fluorescent response of the sample. Such a scheme would also eliminate the need for a rolling shutter or confocal slit, since fluorescence is only generated by the sample in the focal plane.

The present method may require about fifteen raw diffraction-limited images to be acquired for generating super-resolution images (e.g., five phases per direction). This number of raw diffraction-limited images may be lessened by building a “rescanning path” on the emission side after the first dichroic mirror 116 so that the sparse fluorescence emission created by the sparse, periodic illumination pattern is optically reassigned to the correct location in the sample 105.

Accordingly, in a variety of embodiments of the disclosure, a multiview super resolution microscopy system (such as microscopy system 100) may comprise at least a first objective setup and a second objective setup (e.g., a first arm and a second arm). The first objective setup may include: a first illumination generator (such as first sharp illumination generator and scanner 113) to provide a first selectively-blanked illumination line scan; a first objective lens (such as first objective 118) to introduce the first selectively-blanked illumination line scan to a sample and to collect a first fluorescence emission from the sample, the first objective lens being oriented along a first directional axis; and a first detector (such as first detector 126) to receive the first fluorescence emission from the objective lens. The second objective setup may include: a second illumination generator (such as second sharp illumination generator and scanner 133) to provide a second selectively-blanked illumination line scan; a second objective lens (such as second objective 138) to introduce the second selectively-blanked illumination line scan to a sample and to collect a second fluorescence emission from the sample, the second objective lens being oriented along a second directional axis oblique to the first directional axis; and a second detector (such as second detector 146) to receive the second fluorescence emission from the objective lens. The multiview super resolution microscopy system may also comprise one or more processors (such as first processor 128 and/or second processor 148) in operative communication with the first detector and the second detector for combining at least the first fluorescence emission and the second fluorescence emission to generate a composite image.

In some embodiments, the first objective lens may be positioned below the sample. For some embodiments, the second objective lens may be positioned above the sample.

In some embodiments, the first objective setup may include a first light source to transmit a first laser beam (such as first illumination source 110) and/or a first fast shutter in operative association with the first illumination generator to collectively blank the first laser beam to produce the first selectively-blanked illumination line scan (such as first fast shutter 112). Similarly, in some embodiments, the second objective setup may include a second light source to transmit a second laser beam (such as second illumination source 130) and/or a second fast shutter in operative association with the second illumination generator to collectively blank the second laser beam to produce the second selectively-blanked illumination line scan (such as second fast shutter 132). For some embodiments, at least one of the first fast shutter and the second fast shutter may include an acousto-optic tunable filter, a fast polarization sensitive shutter, a fast shutter provided within a head of the respective light source, and/or a fast mechanical shutter.

For some embodiments, the first objective setup may include a first dichroic mirror in communication with the first objective lens to separate the first selectively-blanked illumination line scan from the first fluorescence emission (such as first dichroic mirror 116). Similarly, for some embodiments, the second objective setup may include a second dichroic mirror in communication with the second objective lens to separate the second selectively-blanked illumination line scan from the second fluorescence emission (such as second dichroic mirror 136).

In some embodiments, the first selectively-blanked illumination line scan may be blanked at a first phase shift, and the second selectively-blanked illumination line scan may be blanked at a second phase shift different from the first phase shift. For some embodiments, the first objective lens may collect the first fluorescence emission in epi-mode and/or the second objective lens may collect the second fluorescence emission in epi-mode.

In some embodiments, the first detector may be operable in a mode to filter out out-of-focus portions of the first fluorescence emission. Similarly, in some embodiments, the second detector may be operable in a mode to filter out out-of-focus portions of the second fluorescence emission.

Some embodiments may comprise a third objective setup, which may include: a third illumination generator (such as third sharp illumination generator and scanner 153) to provide a third selectively-blanked illumination line scan; a third objective lens (such as third objective 158) to introduce the third selectively-blanked illumination line scan to a sample and to collect a third fluorescence emission from the sample, the third objective lens being oriented along a third directional axis oblique to the first directional axis and different from the second directional axis; and a third detector (such as third detector 166) to receive the third fluorescence emission from the objective lens. The one or more processors (such as first processor 128, second processor 148, and/or third processor 168) may be in operative communication with the first detector, the second detector, and the third detector for combining at least the first fluorescence emission, the second fluorescence emission, and the third fluorescence emission to generate the composite image.

In some embodiments, the third directional axis may be substantially orthogonal to the second directional axis. For some embodiments, the first objective lens may be positioned below the sample and/or the second objective lens and the third objective lens may be positioned above the sample.

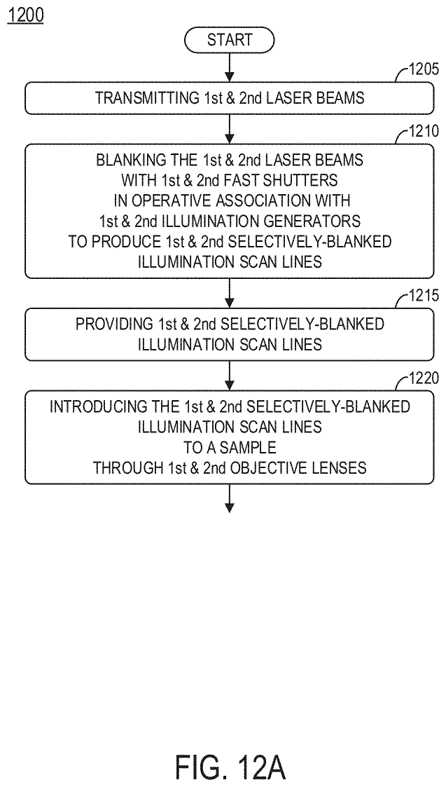

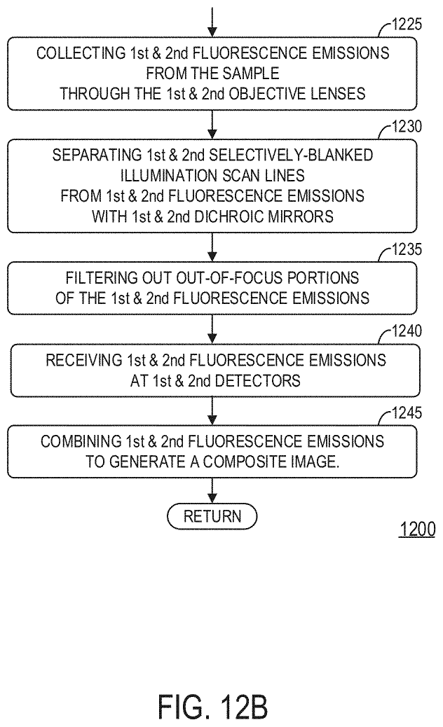

FIGS. 12A and 12B show a flow diagram of a method for performing multiview SIM. A method 1200 of multiview super-resolution microscopy may comprise a providing 1215, an introducing 1220, a collecting 1225, a receiving 1240, and a combining 1245. In various embodiments, method 1200 may also comprise a transmitting 1205, a blanking 1210, a separating 1230, and/or a filtering-out 1235.

In providing 1215, a first selectively-blanked illumination line scan and a second selectively-blanked illumination line scan may be provided. In introducing 1220, the first selectively-blanked illumination line scan may be introduced to a sample (such as sample 105) through a first objective lens (such as first objective 118), and the second selectively-blanked illumination line scan may be introduced to the sample through a second objective lens (such as second objective 138), the first objective lens being oriented toward the sample from a first direction, and the second objective lens being oriented to the sample from a second direction at an obtuse angle to the first direction. In collecting 1225, a first fluorescence emission may be collected from the sample through the first objective lens, and a second fluorescence emission may be collected from the sample through the second objective lens. In receiving 1240, the first fluorescence emission may be collected at a first detector (such as first detector 126), and the second fluorescence emission may be collected at a second detector (such as second detector 146). In combining 1245, at least the first fluorescence emission and the second fluorescence emission may be combined to generate a composite image.

In some embodiments, in transmitting 1205, a first laser beam and a second laser beam (such as first illumination source 110 and second illumination source 130) may be transmitted. For some embodiments, in blanking 1210, the first laser beam may be blanked with a first fast shutter (such as first fast shutter 112) in operative association with a first illumination generator (such as first sharp illumination generator and scanner 113) to produce the first selectively-blanked illumination line scan, and the second laser beam may be blanked with a second fast shutter (such as second fast shutter 132) in operative association with a second illumination generator (such as second sharp illumination generator and scanner 133) to produce the second selectively-blanked illumination line scan.

In some embodiments, at least one of the first fast shutter and the second fast shutter includes an acousto-optic tunable filter, a fast polarization sensitive shutter, a fast shutter provided within a head of the respective light source, and/or a fast mechanical shutter. For some embodiments, in separating 1230, the first selectively-blanked illumination line scan may be separated from the first fluorescence emission with a first dichroic mirror (such as first dichroic mirror 116), and the second selectively-blanked illumination line scan may be separated from the second fluorescence emission with a second dichroic mirror (such as second dichroic mirror 136).

In some embodiments, the blanking of the first selective-blanked illumination line scan may be at a first phase shift, and the blanking of the second selective-blanked illumination line scan may be at a second phase shift different from the first phase shift. For some embodiments, the first fluorescence emission and the second fluorescence emission may be collected in epi-mode. In some embodiments, in filtering-out 1235, out-of-focus portions of the first fluorescence emission and out-of-focus portions of the second fluorescence emission may be filtered out.

In some embodiments, method 1200 of multiview super-resolution microscopy may comprise an additional transmitting, blanking, providing, introducing, collecting, separating, filtering-out, receiving, and/or combining for one or more additional arms of a microscopy setup, and their component elements, as disclosed herein. For example, for embodiments in which method 1200 is extended to a third arm of a microscopy setup, a third selectively-blanked illumination line scan may be introduced to the sample through a third objective lens (such as third objective 158, the third objective lens being oriented to the sample from a third direction at an obtuse angle to the first direction, and the third direction being different than the second direction. In some embodiments, the third direction may be oriented at a substantially right angle to the second direction.

Another representation of the systems and methods disclosed herein pertains to the incorporation of optical reassignment into microscopy systems. As disclosed herein, about fifteen raw diffraction-limited images may be acquired for generating super-resolution images (e.g., five phases in each of three directions). In some embodiments, this number of raw diffraction-limited images may advantageously be lessened by building a “rescanning path” on the emission side (e.g., after a dichroic mirror, such as first dichroic mirror 116), so that the sparse fluorescence emission created by the sparse, periodic illumination pattern is optically reassigned to the correct location in the sample 105.

FIG. 5 is a schematic illustration of portions of a microscopy system incorporating structures in support of optical reassignment (e.g., for performing real-time super-resolution imaging). Microscopy system 500 may be one arm of a microscopy system (e.g., a super-resolution microscopy system) for illuminating a sample. Microscopy system 500 may have a 2D scanning capability. In some embodiments, microscopy system 500 may be substantially similar to microscopy system 100. Furthermore, the structures discussed below may be implemented for one arm of microscopy system 500, or for more than one arm, up to and including all arms of microscopy system 500. Accordingly, in various embodiments, similar optics and structures may be installed for further objectives of microscopy system 500 (e.g., two upper objectives of the microscopy system 500, where microscopy system 500 employs a three-objective setup such as microscopy system 100). Accordingly, similar functionality may be provided to multiple objective lenses for providing super-resolution imaging. In effectuating an optical reassignment process, microscopy system 500 may advantageously enable super-resolution image generation with only three images (one image per view), thereby providing a five-fold improvement in data acquisition speed.

Microscopy system 500 is depicted as including an illumination source 510 (e.g., a laser source such as a fiber-coupled laser) to generate and transmit a laser beam 511, which may be focused to a sharp illumination structure, and which in turn passes through a 2D excitation scanner 513. In various embodiments, laser beam 511 may be scanned in either a 1D scan or a 2D scan. 2D excitation scanner 513 then scans laser beam 511 through a first lens pair 515 (L1 and L2) and a dichroic mirror 516 before laser beam 511 is scanned through a sample 505 by objective 518.

Once laser beam 511 is scanned through sample 505, fluorescence emissions 519 emitted by sample 505 are collected in epi-mode by objective 518 and presented to dichroic mirror 516, which redirects and focuses them fluorescence emissions 519 through a second lens pair 521 (L3 and L4) and a 2D emission descanner 522. Fluorescence emissions 519 are then descanned by 2D emission descanner 522 before a third lens pair 523 (L5 and L6) focuses them through an adjustable pinhole 524 to remove out-of-focus fluorescence emissions from fluorescence emissions 519.

After the out-of-focus fluorescence emissions are removed, in-focus fluorescence emissions 525 are rescanned by a 2D emission rescanner 526 before a tube lens 529 (L7) focuses the rescanned in-focus fluorescence emissions 527 onto a detector 530 (which may be, or may include, a camera or a camera chip). In some embodiments, first lens pair 515, second lens pair 521, and/or third lens pair 523 may be, or may include, relay telescopes that map one image plane onto another image plane.

The systems and methods disclosed herein may advantageously provide a serial acquisition scheme in which one volume is acquired from each view serially in time. In principle, microscopy system 500 may be operated in a “parallel” mode, wherein each view is simultaneously recorded. In this “parallel” mode, the microscopy system 500 may advantageously provide a three-fold improvement in overall acquisition speed. System 500 may also potentially introduce more out-of-focus fluorescence emissions 519 and/or degrading optical sectioning in each view; however, the scanning of a confocal slit with each line illumination may mitigate the degradation in optical sectioning to some extent.

In comparison with light-sheet microscopy, in which the illumination of the sample is confined to the vicinity of the focal plane, for the systems and methods disclosed herein, a sample (e.g., sample 505) may be illuminated volumetrically. As such, there may be “wastage” of fluorescence emissions from the illuminated sample that are emitted, but not collected and detected.

Some of the wasted fluorescence emissions may be collected during a single illumination from any one view by rapidly scanning the objective from a second view along the appropriate axis, so that its detection plane is coincident with the illumination plane (e.g., of the objective of the first view). Although implementing this additional collection process may lead to more complexity for acquisition hardware, doing so may advantageously help to collect more of the fluorescence emissions and/or improve a related signal-to-noise ratio.

In various embodiments, larger gains in reducing phototoxicity and/or improving acquisition speed may be obtained by using advanced processing methods such as deep learning based methods and/or convolutional neural network (CNN) based methods. The ability to collect both raw data from each view and produce “physics-based” reconstructions implies that the microscopy systems disclosed herein (e.g., microscopy system 500) can provide a robust source of “training data” and “ground truth” data for CNN based strategies.

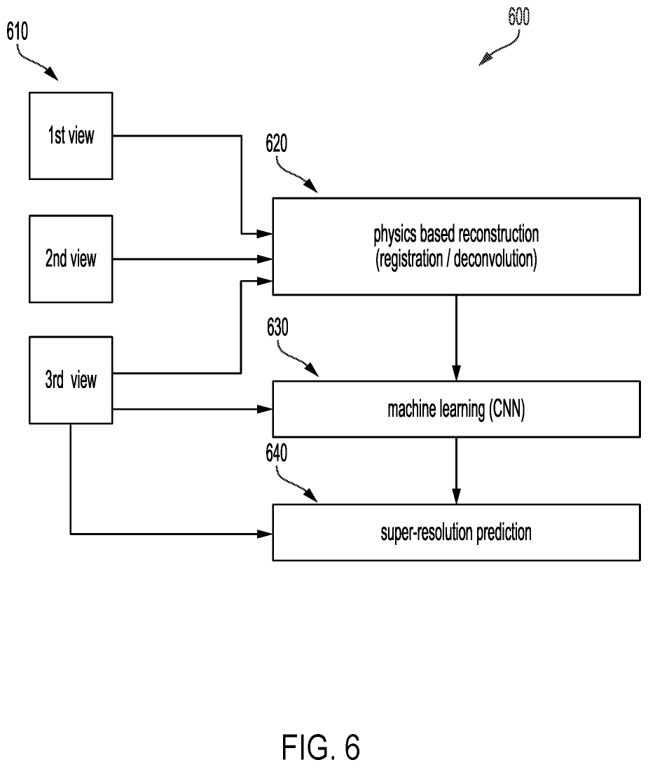

FIG. 6 is a schematic illustration of a system for using machine learning to obtain super-resolution data. A system 600 may accept data from one or more views 610, which may include, for example, raw volumetric data or images of a sample from one or more of views 610. A first component 620 may then use physics-based reconstruction to produce an improved-resolution image (which may include, e.g., registering and/or deconvolving views) based on the raw volumetric data or images of the sample.

The raw volumetric data or images may then be paired with corresponding physics-based reconstructions and passed to second component 630, which may be or may include a CNN. Based on the paired data, the CNN may be trained to perform a super-resolution prediction, which may represent, e.g., a prediction of super-resolved data based upon raw volumetric data or images from one or more views. In various embodiments, deep learning may also be used to denoise raw data, which may advantageously further reduce experiment duration and lower phototoxicity.

Subsequently, a third component 640 may be presented with raw volumetric data or images, perhaps from merely a single view (e.g., as depicted, the third view). Having been trained to predict physics-based reconstructions, the CNN may then advantageously enable a microscopy system to bypass the collection of data that may otherwise be used to generate physics-based reconstructions (e.g., raw volumetric data or images, such as from all views of a multiview microscopy system). Instead, high-quality super-resolution predictions may be made directly from as few as one of the raw views, which may advantageously enable a dramatic improvement in the speed of acquisition. The systems and methods disclosed herein may accordingly generate data that may enable the combination of “physics-based” models for resolution improvement with “machine-learning” based models, which may advantageously improve spatial resolution at high speeds and/or low illumination doses.

Accordingly, in a further variety of embodiments of the disclosure, a multiview super resolution microscopy system (such as microscopy system 100 and/or microscopy system 500) may comprise an objective setup, which may in turn include: a 2D excitation scanner (such as 2D excitation scanner 513) to provide a scanned laser beam; an objective lens (such as objective 518) to introduce the scanned laser beam to a sample (such as sample 505) and to collect a fluorescence emission (such as fluorescence emissions 519) from the sample; a 2D descanner (such as 2D emission descanner 522) to descan the fluorescence emission; an adjustable pinhole (such as adjustable pinhole 524) to remove out-of-focus emissions from the descanned fluorescence emission; a 2D rescanner (such as 2D emission rescanner 526) to rescan the descanned fluorescence emission that passes through the adjustable pinhole; and a detector (such as detector 530) to receive the rescanned fluorescence emission. The multiview super resolution microscopy system may further comprise one or more processors in operative communication with the detector to generate an image based upon at least the rescanned fluorescence emission.

In some embodiments, the objective setup may further include a dichroic mirror (such as dichroic mirror 516) to separate the fluorescence emission from the scanned laser beam. For some embodiments, the objective setup may further include a lens pair (such as first lens pair 515) to focus the scanned laser beam on the objective lens, a second lens pair (such as second lens pair 521) to focus the fluorescence emission to the 2D descanner and/or a third lens pair (such as third lens pair 523) comprising a first lens positioned on a first side of the adjustable pinhole and a second lens positioned on a second side of the adjustable pinhole opposite to the first side. In some embodiments, the objective setup may further include tube lens (such as tube lens 529) to focus the rescanned fluorescence emission onto the detector, the tube lens being positioned between the two-dimensional rescanner and the detector.

For some embodiments, the detector may comprise a camera. In some embodiments, the objective lens may collect the fluorescence emission in epi-mode. For some embodiments, the sample may be illuminated volumetrically by the scanned single laser beam.

In some embodiments, the multiview super resolution microscopy system may further comprise a second objective setup and/or a third objective setup. The second objective setup may comprise: a second 2D excitation scanner to provide a second scanned laser beam; a second objective lens to introduce the second scanned laser beam to a sample and to collect a second fluorescence emission from the sample; a second 2D descanner to descan the second fluorescence emission; a second adjustable pinhole to remove out-of-focus emissions from the descanned second fluorescence emission; a second 2D rescanner to rescan the descanned second fluorescence emission that passes through the second adjustable pinhole; and a second detector to receive the rescanned second fluorescence emission (any or all of which may be similar to similarly-named elements of the first objective setup). The third objective setup may include: a third 2D excitation scanner to provide a third scanned laser beam; a third objective lens to introduce the third scanned laser beam to a sample and to collect a third fluorescence emission from the sample; a third 2D descanner to descan the third fluorescence emission; a third adjustable pinhole to remove out-of-focus emissions from the descanned third fluorescence emission; a third 2D rescanner to rescan the descanned third fluorescence emission that passes through the third adjustable pinhole; and a third detector to receive the rescanned third fluorescence emission (any or all of which may be similar to similarly-named elements of the first objective setup). The one or more processors may be in operative communication with the detector, the second detector, and the third detector to generate the image based upon at least the rescanned fluorescence emission, the rescanned second fluorescence emission, and the rescanned third fluorescence emission.

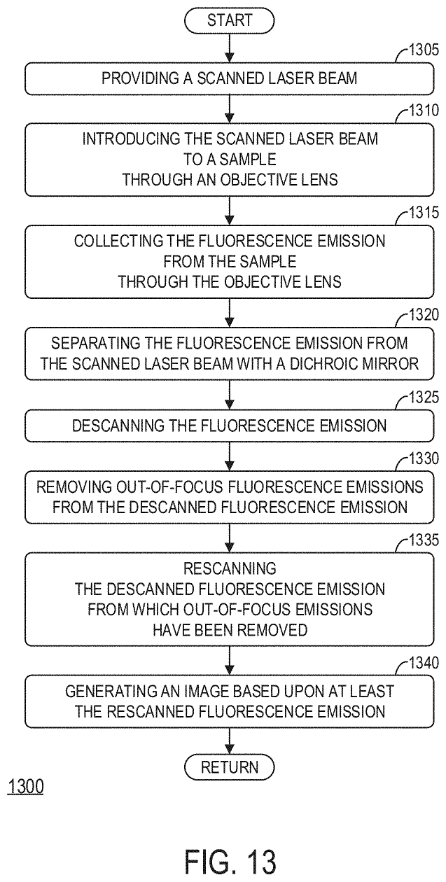

FIG. 13 shows a flow diagram of a method for incorporating optical reassignment into microscopy. A method 1300 of multiview super-resolution microscopy comprises a providing 1305, an introducing 1310, a collecting 1315, a descanning 1325, a removing 1330, a rescanning 1335, and a generating 1340. In various embodiments, method 1300 may additionally comprise a separating 1320.

In providing 1305, a scanned laser beam may be provided. In introducing 1310, the scanned laser beam may be introduced to a sample (such as sample 505) through an objective lens (such as objective 518). In collecting 1315, a fluorescence emission (such as fluorescence emissions 519) may be collected from the sample through the objective lens. In descanning 1325, the fluorescence emission may be descanned. In removing 1330, out-of-focus fluorescence emissions may be removed from the descanned fluorescence emission. In rescanning 1335, the descanned fluorescence emission from which out-of-focus emissions have been removed may be rescanned. In generating, an image may be generated based upon at least the rescanned fluorescence emission. In some embodiments, in separating 1320, the fluorescence emission from the scanned laser beam with a dichroic mirror (such as dichroic mirror 516).

For some embodiments, the detector may comprise a camera. In some embodiments, the objective lens may collect the fluorescence emission in epi-mode. For some embodiments, the sample may be illuminated volumetrically by the scanned single laser beam.

Another representation of the systems and methods disclosed herein pertains to the use of microscopy systems for supporting isotropic in-plane super-resolution microscopy. The systems and methods disclosed herein may advantageously improve a spatial resolution of line-scanning confocal microscopy by providing isotropic, in-plane super-resolution. The same concepts may advantageously be extended to improve speed and/or reduce phototoxicity in various microscopy techniques, including: SIM; lattice-light-sheet microscopy; SIM and lattice-light-sheet microscopy in their nonlinear modes; stimulated emission depletion (STED) microscopy; reversible saturable optical fluorescence transitions (RESOLFT) microscopy; and any other microscopy techniques in which spatial resolution may be improved along one spatial dimension. The systems and methods disclosed herein combine innovations in optical microscopy, computational microscopy, image reconstruction, and machine learning (or deep learning).

Line confocal microscopy may illuminate a fluorescently-labeled sample with a sharp, diffraction-limited illumination that is focused in one spatial dimension. If the resulting fluorescence is filtered through a slit and recorded as the line is scanned across the sample, an optically-sectioned image with reduced contamination from out-of-focus fluorescence may be obtained. The fact that the illumination is diffraction-limited implies that if additional images are acquired, or if optical reassignment techniques are used, spatial resolution may be improved in the direction in which the line is focused (e.g., along one spatial dimension). However, such techniques for improving 1D resolution in line confocal microscopy may undesirably impart more dose or require more images than conventional, diffraction-limited confocal microscopy.

The systems and methods disclosed herein may supply 2D, isotropic super-resolution without any drawback in speed or increase in dose relative to conventional line confocal microscopy. The systems and methods may therefore be relatively attractive for, e.g., rapid, optically-sectioned super-resolution imaging in living samples.

In a first step, spatial resolution is improved along one dimension by taking a series of images with sparse, phase-shifted diffraction-limited line illumination patterns and processing them using photon-reassignment and/or deconvolution (e.g., physics-based reconstruction). As discussed regarding FIG. 2 above, if a line such as a single laser beam is scanned horizontally (e.g., from left to right), synchronously with a rolling-shutter pixel line readout of a detector such as a camera, an optically-sectioned image results, but the resulting image will remain diffraction-limited (as in scenario 210). However, if the single laser beam is blanked as the line scans from left to right (e.g., through the use of a fast shutter), sparse periodic illumination patterns may result. Various numbers of phases may be used in blanking the line, with an image created for each phase (with images for three such phases, shifted by about 120 degrees relative to each other, being depicted in scenario 220). These sparse, diffraction-limited images may then be combined into a super-resolution image, where resolution is improved approximately two-fold in the direction of scan. After this procedure, spatial resolution may be improved in one spatial dimension.

One approach to improving resolution along additional axes, thereby making spatial resolution more isotropic, may involve rotating the line illumination pattern along a series of angles, and again performing the same operations as discussed above regarding FIG. 2 (e.g., related to scenario 220 and scenario 230). However, this may undesirably decrease temporal resolution and increase specimen illumination dose, in direct proportion to the number of additional angles sampled.

Another approach may involve using multiple objectives that illuminate with line illumination along different Cartesian axes, then fuse the resulting data together, thereby generating a composite image with improved resolution along all three dimensions. However, this method may also undesirably decrease temporal resolution and increase dose.

Yet another approach may involve using optical reassignment (e.g., scanning the illumination, descanning the resulting fluorescence, and rescanning the resulting fluorescence), as disclosed further herein. This approach may advantageously operate at higher speed, but may still increase illumination dose relative to diffraction-limited line confocal microscopy, and may still suffer slower speed than diffraction-limited line confocal microscopy.

In various embodiments based upon the systems and methods disclosed herein, spatial resolution may be directly improved on every sample. Sets of training data (for use in training neural networks, such as CNNs) may be built using sample images processed as discussed herein regarding FIG. 2. For a given specimen or sample type, a set of matched pairs of diffraction-limited line-confocal images and 1D super-resolved images may be collected.

FIG. 7 shows a schematic illustration of paired diffraction-limited images and 1D super-resolved images (e.g., for a given specimen or sample type). A training set 700 may include a first diffraction-limited line-confocal image 711, a second diffraction-limited line-confocal image 712, and so on, up through an Nth diffraction-limited line-confocal image 719. Training set 700 may also include a first 1D super-resolved image 721, a second 1D super-resolved image 722, and so on, up through an Nth 1D super-resolved image 729. Accordingly, training set 700 may include N matched pairs of diffraction-limited images and 1D super-resolved images.

The elements of the N image pairs (e.g., images of cells) with fluorescently labeled structures (shaded) may be imaged in diffraction-limited modes (left) and super-resolved modes (right). In some embodiments, diffraction-limited line-confocal images may be obtained simply by summing the raw phase images described regarding FIG. 2. For various embodiments, diffraction-limited images may be acquired with line-confocal microscopy by line scanning in a horizontal direction. For some embodiments, post-processing a series of images with sparse line illumination structure (as in FIG. 2) may result in the images at right, with resolution enhancement along the horizontal direction.

If a sufficient number of such training pairs can be assembled in training set 700 (e.g., on different cells, or on samples labeled with the same fluorescent marker), the lack of any preferred orientation in the underlying samples may imply that a large range of randomly-oriented structures has been sampled, and that a corresponding large range of 1D super-resolution images has been generated. Training set 700 may therefore be used for training a neural network, such as a CNN, with the N image pairs being training pairs.

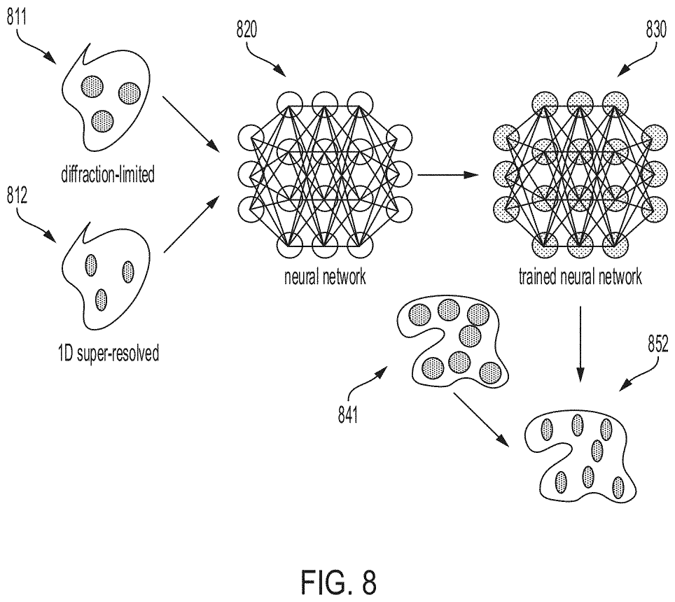

Once a training corpus or training set has been assembled (such as training set 700), it can be used to train a neural network (e.g., a U-Net neural network, an RCAN neural network, or another neural network or CNN). The trained neural network may then be used to predict a 1D super-resolution image for a diffraction-limited image input that it has never “seen” before (FIG. 8).

FIG. 8 shows a schematic illustration of the use of neural networks to predict 1D super-resolved images (e.g., based on the paired images of FIG. 7). A training dataset may include matched pairs of diffraction-limited images 811 and 1D super-resolved images 812 (e.g., with resolution enhancement along one spatial dimension). The matched pairs of images 811 and 812 may then be supplied to a neural network 820 to create a trained neural network 830 (e.g., for the specimen or sample type for which images 811 and 812 were obtained). Trained neural network 820 may subsequently accept one or more diffraction-limited images 841 (e.g., that it has never “seen” before), and may predict corresponding 1D super-resolved images 852, which may advantageously be highly accurate.

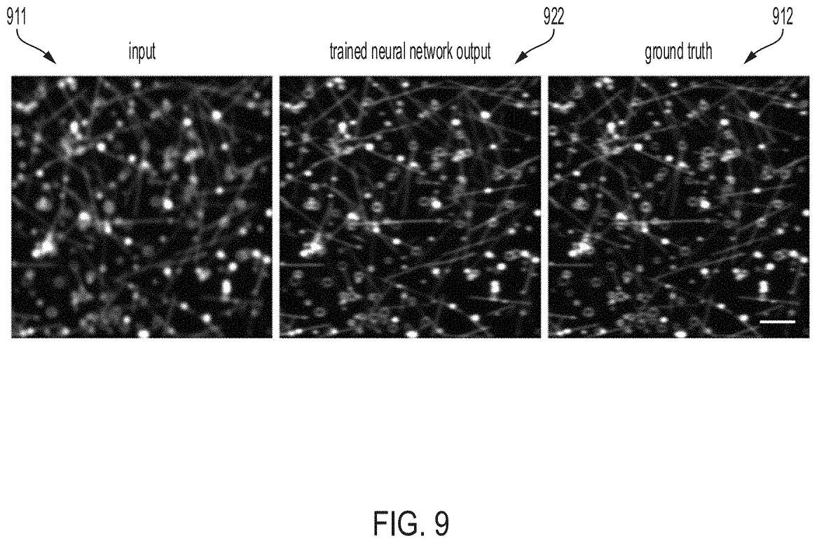

FIG. 9 shows images related to the use of the neural networks of FIG. 8. An image 911 is a simulated diffraction-limited image for a given specimen or sample type. The simulated data comprises a mixed structure of dots, lines, rings, and solid circles. Image 911 may be relatively blurred, with a 2D symmetric diffraction-limited PSF. An image 912 is a simulated 1D super-resolved image for the given specimen or sample type. When provided with image 911, a neural network (which has been trained with image pairs for the given specimen or sample type) produces image 922, which is a predicted 1D super-resolved image. (The scale bar represents 5 μm.)

For purposes of comparison, image 912 may represent a ground-truth against which predicted image 922 may be compared. Based on tests with simulated data, this method may advantageously reliably yield super-resolved data along one spatial dimension, suggesting that it is possible to obtain 1D super-resolved data from raw confocal data without performing physics-based reconstructions such as depicted in FIG. 2. Thus, with a suitably trained network (e.g., trained neural network 820), predicted 1D super-resolved data may be obtained directly from diffraction-limited data without sacrificing temporal resolution or introducing more illumination dose.

The systems and methods discussed above may accordingly generate 1D super-resolution images. As discussed below, the systems and methods for producing these 1D super-resolution images may be extended to yield images with isotropic super-resolution.

Using the systems and methods discussed above, a diffraction-limited line-confocal image for a given specimen or sample type (such as image 841) can be rotated at a series of angles to produce a corresponding series of rotated diffraction-limited line-confocal images. Each of these rotated images may be provided to a neural network trained for the given specimen or sample type, which may then produce a series of images in which 1D super-resolution has been attained, but the dimensions in which the 1D super-resolution has been attained in each image are at different angles.

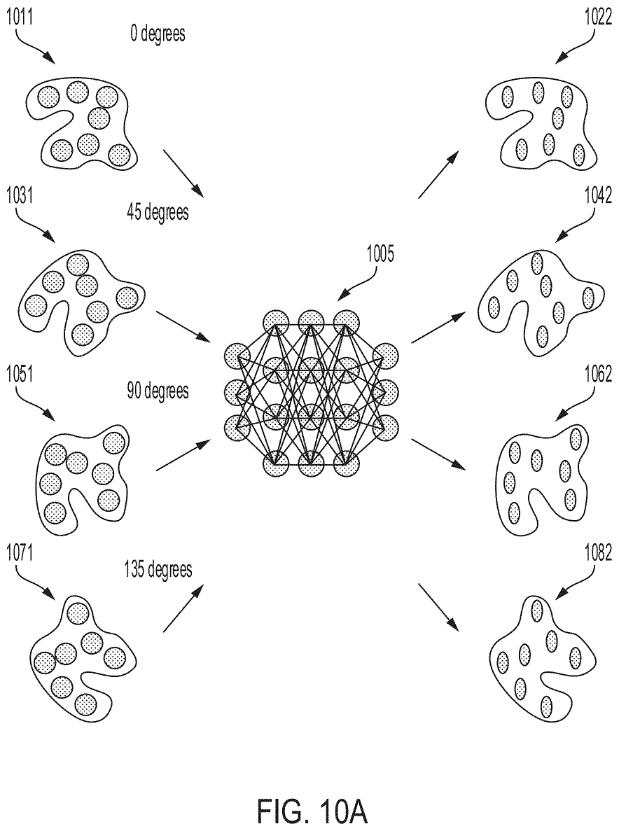

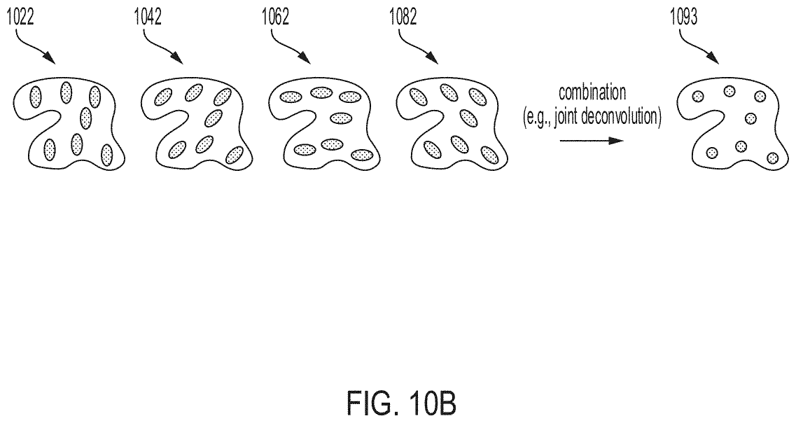

FIGS. 10A and 10B show schematic illustrations of the use of neural networks trained to predict 1D super-resolved images to produce predicted isotropic super-resolved images. In FIG. 10A, a first image 1011, a second image 1031, a third image 1051, and a fourth image 1071 may be the diffraction-limited line-confocal image rotated at each of a first angle, a second angle, a third angle, and a fourth angle (e.g., 0 degrees, 45 degrees, 90 degrees, and 135 degrees). Images 1011, 1031, 1051, and 1071 may be provided to trained neural network 1005, which may then produce a corresponding first super-resolved image 1022, a second super-resolved image 1042, a third super-resolved image 1062, and a fourth super-resolved image 1082. Each of super-resolved images 1022, 1042, 1062, and 1082 may be 1D super-resolved versions of the original diffraction-limited line-confocal image. The super-resolved images may accordingly have resolution enhancement in the horizontal direction, as rotated, but may be super-resolved in dimensions that are at different angles with respect to each other with respect to the frame of the original image.

As illustrated in FIG. 10B, if images 1022, 1042, 1062, and 1082 are then rotated back into the frame of the original image (e.g., rotated at 0 degrees), they may be combined (e.g., with a joint deconvolution based algorithm) to yield an image 1093 with isotropic in-plane super-resolution. Image 1093 may thus be an image with isotropic super-resolution, meaning the best resolution along each direction. In various embodiments, the systems and methods disclosed herein may work most successfully when more than two rotations of an original image are used.

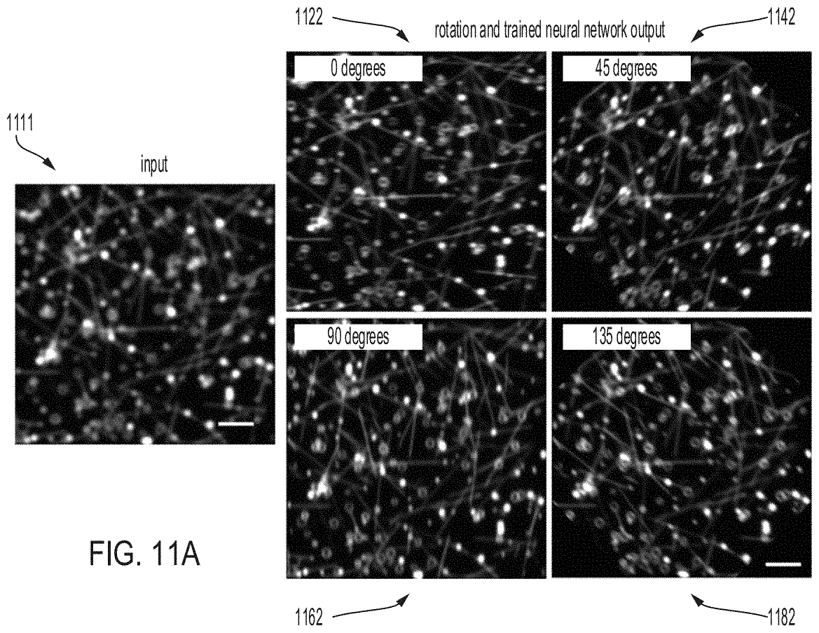

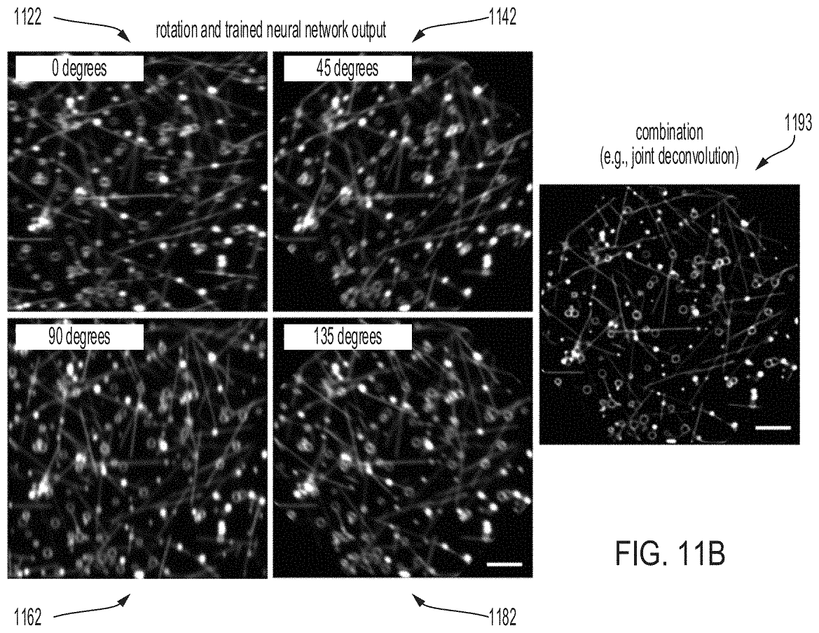

FIGS. 11A and 11B show images related to the use of the neural networks of FIGS. 10A and 10B, in accordance with one or more embodiments of the present disclosure. An image 1111 is a simulated diffraction-limited image for a given specimen or sample type (e.g., a mixture of dots, lines, rings and solid circles, blurred with a diffraction-limited PSF, with Poisson and/or Gaussian noise added) and may be substantially similar to image 911. Each of images 1122, 1142, 1162, and 1182 are simulated 1D super-resolved images corresponding with image 1111 rotated at a first angle, a second angle, a third angle, and a fourth angle (e.g., 0 degrees, 45 degrees, 90 degrees, and 135 degrees), as discussed above regarding FIGS. 10A and 10B. (The scale bar represents 5 μm.)

Images 1122, 1142, 1162, and 1182 may then be rotated back into the frame of image 1111 and combined (e.g., via a joint deconvolution based algorithm) to produce an image 1193 with isotropic super-resolution in 2D. In comparison with image 912 (a simulated 1D super-resolved image corresponding with image 911) and in comparison with image 922 (a predicted 1D super-resolved image), image 1193 has substantially higher resolution and clarity.

In various embodiments, a line confocal microscope may be used to produce pairs of diffraction-limited images and 1D super-resolved images of the same sample. These image pairs may then be used to train a neural network that improves 1D resolution. The neural network may then provide 1D resolution enhancement to additional diffraction-limited images. For example, diffraction limited images that have been rotated, e.g., at a series of angles, may be used as input to the neural network, which may produce a corresponding series of rotated images, each with resolution enhancement along a different direction relative to a frame of the original image. When such images are combined (e.g., with a deconvolution algorithm, such as joint deconvolution), an image with isotropic resolution may be produced.

Significantly, after the neural network is trained, super-resolution images may advantageously be produced from line confocal images without any loss in speed or increase in dose relative to the base diffraction-limited images. Thousands of line confocal microscopes are currently in use, and the systems and methods disclosed herein may enable them to produce images with improved resolution with no (or minimal) hardware modification. Accordingly, the methods and systems disclosed herein may broadly impact the field of microscopy.

Moreover, the systems and methods disclosed herein may also be applicable to other techniques for introducing sharp structured illumination other than confocal microscopy, such as 3D SIM and lattice light-sheet microscopy. For example, 3D SIM techniques may employ fifteen raw images, by acquiring and then post-processing five phases at three rotations per phase to yield an image with resolution doubling in all three dimensions. Application of the systems and methods disclosed herein may enable reconstructed images with similar resolution enhancement, based on merely five images (instead of fifteen). As another example, with lattice light-sheet microscopy, super-resolution may be possible in one dimension in the focal plane. Application of the systems and methods disclosed herein to such data may improve resolution so that it is isotropic in the focal plane. Finally, STED and RESOLFT may accommodate unlimited resolution enhancement in principle, although in practice such techniques may be limited by severe photobleaching. Application of the systems and methods disclosed herein, modified for 1D resolution enhancement instead of 2D resolution enhancement, may drastically lessen such photobleaching and improve imaging speed. As a result, use of the systems and methods disclosed herein to recover the full 2D resolution enhancement may thus advantageously result in improved imaging for these super-resolution techniques.

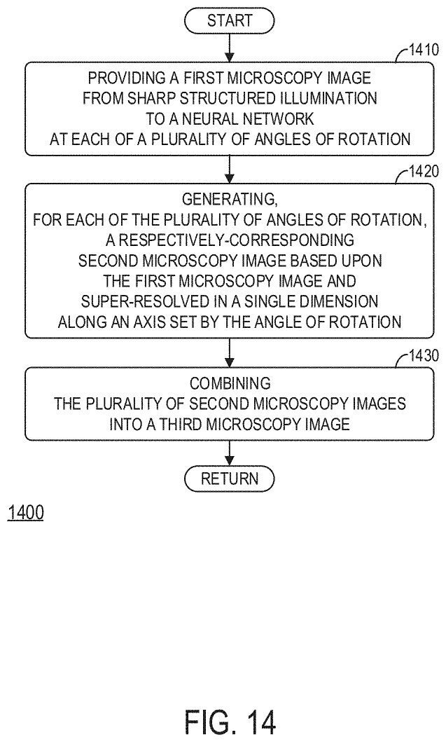

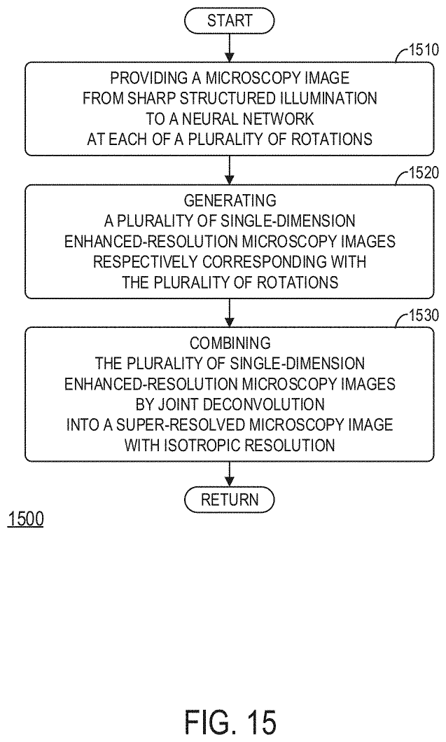

FIGS. 14 and 15 show methods for producing isotropic super-resolved images. Regarding FIG. 14, a method 1400 may comprise a providing 1410, a generating 1420, and a combining 1430. In providing 1410, a first microscopy image derived from sharp structured illumination may be provided to a neural network at each of a plurality of angles of rotation. In generating 1420, for each of the plurality of angles of rotation, a respectively-corresponding second microscopy image may be generated, based upon the first microscopy image and super-resolved in a single dimension along an axis set by the angle of rotation. In combining 1430, the plurality of second microscopy images may be combined into a third microscopy image. The third microscopy image may be super-resolved in a plurality of directions respectively corresponding with plurality of angles of rotation.

For some embodiments, the neural network may be trained based on pairs of images each of which include a microscopy image derived from sharp structured illumination that is non-super-resolved and a corresponding second microscopy image that is super-resolved in a single dimension. In some embodiments, the plurality of angles of rotation may include at least four angles. For some embodiments, the plurality of angles of rotation may include at least six angles. In some embodiments, the angles of rotation may be spaced by a substantially uniform increment. For some embodiments, the plurality of second microscopy images may be combined into the third microscopy image by joint deconvolution. In some embodiments, the first microscopy image may be a diffraction-limited confocal microscopy image.

Regarding FIG. 15, a method 1500 of producing a super-resolution microscopy image with isotropic resolution may comprise a providing 1510, a generating 1520, and a combining 1530. In providing 1510, a microscopy image derived from sharp structured illumination may be provided to a neural network at each of a plurality of rotations. In generating 1520, a plurality of single-dimension enhanced-resolution microscopy images respectively corresponding with the plurality of rotations may be generated. In combining 1530, the plurality of single-dimension enhanced-resolution microscopy images may be combined by joint deconvolution into the super-resolved microscopy image with isotropic resolution.

In some embodiments, the neural network may be trained based on pairs of images, each of which include a first microscopy image derived from sharp structured illumination that is not super-resolved in any dimension and a corresponding second microscopy image that is super-resolved in a single dimension. For some embodiments, the plurality of rotations are at angles of pi radians divided by an integer greater than or equal to four. In some embodiments, the plurality of rotations are at angles of pi radians divided by an integer greater than or equal to six.

Instructions for carrying out methods 1300, 1400, and 1500, and other methods disclosed herein, may be executed by one or more processors based on instructions stored in a memory for the processors.

FIGS. 1 and 5 show example configurations with relative positioning of the various components. Elements shown contiguous or adjacent to one another may be contiguous or adjacent to each other, respectively, at least in one example. Elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example.

The description of embodiments has been presented for purposes of illustration and description. Suitable modifications and variations to the embodiments may be performed in light of the above description or may be acquired from practicing the methods. For example, unless otherwise noted, one or more of the described systems and methods may be implemented by a suitable device and/or combination of devices, such as the microscopy systems and methods pertaining thereto with respect to FIGS. 1-15. The methods may be performed by executing stored instructions with one or more logic devices (e.g., processors) in combination with one or more additional hardware elements, such as storage devices, memory, image sensors/lens systems, light sensors, hardware network interfaces/antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

The disclosure also provides support for a multiview super resolution microscopy system comprising: a first objective setup including: a first illumination generator to provide a first selectively-blanked illumination line scan, a first objective lens to introduce the first selectively-blanked illumination line scan to a sample and to collect a first fluorescence emission from the sample, the first objective lens being oriented along a first directional axis, and a first detector to receive the first fluorescence emission from the objective lens, and a second objective setup including: a second illumination generator to provide a second selectively-blanked illumination line scan, a second objective lens to introduce the second selectively-blanked illumination line scan to a sample and to collect a second fluorescence emission from the sample, the second objective lens being oriented along a second directional axis oblique to the first directional axis, and a second detector to receive the second fluorescence emission from the objective lens, and one or more processors in operative communication with the first detector and the second detector for combining at least the first fluorescence emission and the second fluorescence emission to generate a composite image. In a first example of the system, the first objective lens is positioned below the sample, and wherein the second objective lens is positioned above the sample. In a second example of the system, optionally including the first example, the first objective setup further includes: a first light source to transmit a first laser beam, and a first fast shutter in operative association with the first illumination generator to collectively blank the first laser beam to produce the first selectively-blanked illumination line scan, and wherein the second objective setup further includes: a second light source to transmit a second laser beam, and a second fast shutter in operative association with the second illumination generator to collectively blank the second laser beam to produce the second selectively-blanked illumination line scan. In a third example of the system, optionally including one or both of the first and second examples, at least one of the first fast shutter and the second fast shutter includes one of: an acousto-optic tunable filter, a fast polarization sensitive shutter, a fast shutter provided within a head of the respective light source, and a fast mechanical shutter. In a fourth example of the system, optionally including one or more or each of the first through third examples, the first objective setup further includes: a first dichroic mirror in communication with the first objective lens to separate the first selectively-blanked illumination line scan from the first fluorescence emission, and wherein the second objective setup further includes: a second dichroic mirror in communication with the second objective lens to separate the second selectively-blanked illumination line scan from the second fluorescence emission. In a fifth example of the system, optionally including one or more or each of the first through fourth examples, the first selectively-blanked illumination line scan is blanked at a first phase shift, and wherein the second selectively-blanked illumination line scan is blanked at a second phase shift different from the first phase shift. In a sixth example of the system, optionally including one or more or each of the first through fifth examples, the first objective lens collects the first fluorescence emission in epi-mode, and wherein the second objective lens collects the second fluorescence emission in epi-mode. In a seventh example of the system, optionally including one or more or each of the first through sixth examples, the first detector is operable in a mode to filter out out-of-focus portions of the first fluorescence emission, and wherein the second detector is operable in a mode to filter out out-of-focus portions of the second fluorescence emission. In an eighth example of the system, optionally including one or more or each of the first through seventh examples, the system further comprises: a third objective setup including: a third illumination generator to provide a third selectively-blanked illumination line scan, a third objective lens to introduce the third selectively-blanked illumination line scan to a sample and to collect a third fluorescence emission from the sample, the third objective lens being oriented along a third directional axis oblique to the first directional axis and different from the second directional axis, and a third detector to receive the third fluorescence emission from the objective lens, wherein the one or more processors are in operative communication with the first detector, the second detector, and the third detector for combining at least the first fluorescence emission, the second fluorescence emission, and the third fluorescence emission to generate the composite image. In a ninth example of the system, optionally including one or more or each of the first through eighth examples, the third directional axis is substantially orthogonal to the second directional axis. In a tenth example of the system, optionally including one or more or each of the first through ninth examples, the first objective lens is positioned below the sample, and wherein the second objective lens and the third objective lens are positioned above the sample.

The disclosure also provides support for a method of multiview super-resolution microscopy comprising: providing a first selectively-blanked illumination line scan, providing a second selectively-blanked illumination line scan, introducing the first selectively-blanked illumination line scan to a sample through a first objective lens, the first objective lens being oriented toward the sample from a first direction, introducing the second selectively-blanked illumination line scan to the sample through a second objective lens, the second objective lens being oriented to the sample from a second direction at an obtuse angle to the first direction, collecting a first fluorescence emission from the sample through the first objective lens, collecting a second fluorescence emission from the sample through the second objective lens, receiving the first fluorescence emission at a first detector, receiving the second fluorescence emission at a second detector, and combining at least the first fluorescence emission and the second fluorescence emission to generate a composite image. In a first example of the method, the method further comprises: transmitting a first laser beam, transmitting a second laser beam, blanking the first laser beam with a first fast shutter in operative association with a first illumination generator to produce the first selectively-blanked illumination line scan, and blanking the second laser beam with a second fast shutter in operative association with a second illumination generator to produce the second selectively-blanked illumination line scan. In a second example of the method, optionally including the first example, at least one of the first fast shutter and the second fast shutter includes one of: an acousto-optic tunable filter, a fast polarization sensitive shutter, a fast shutter provided within a head of the respective light source, and a fast mechanical shutter. In a third example of the method, optionally including one or both of the first and second examples, the method further comprises: separating the first selectively-blanked illumination line scan from the first fluorescence emission with a first dichroic mirror, and separating the second selectively-blanked illumination line scan from the second fluorescence emission with a second dichroic mirror. In a fourth example of the method, optionally including one or more or each of the first through third examples, the blanking of the first selective-blanked illumination line scan is at a first phase shift, and wherein the blanking of the second selective-blanked illumination line scan is at a second phase shift different from the first phase shift. In a fifth example of the method, optionally including one or more or each of the first through fourth examples, the first fluorescence emission and the second fluorescence emission are collected in epi-mode. In a sixth example of the method, optionally including one or more or each of the first through fifth examples, the method further comprises: filtering out out-of-focus portions of the first fluorescence emission, and filtering out out-of-focus portions of the second fluorescence emission. In a seventh example of the method, optionally including one or more or each of the first through sixth examples, the method further comprises: providing a third selectively-blanked illumination line scan, introducing the third selectively-blanked illumination line scan to the sample through a third objective lens, the third objective lens being oriented to the sample from a third direction at an obtuse angle to the first direction, and the third direction being different than the second direction, collecting a third fluorescence emission from the sample through the third objective lens, receiving the third fluorescence emission at a third detector, and combining at least the first fluorescence emission, the second fluorescence emission, and the third fluorescence emission to generate the composite image. In an eighth example of the method, optionally including one or more or each of the first through seventh examples, the third direction is oriented at a substantially right angle to the second direction.

In another representation, the disclosure also provides support for a multiview super resolution microscopy system comprising: an objective setup including: a 2D excitation scanner to provide a scanned laser beam, an objective lens to introduce the scanned laser beam to a sample and to collect a fluorescence emission from the sample, a 2D descanner to descan the fluorescence emission, an adjustable pinhole to remove out-of-focus emissions from the descanned fluorescence emission, a 2D rescanner to rescan the descanned fluorescence emission that passes through the adjustable pinhole, and a detector to receive the rescanned fluorescence emission, and one or more processors in operative communication with the detector to generate an image based upon at least the rescanned fluorescence emission. In a first example of the system the objective setup further including: a dichroic mirror to separate the fluorescence emission from the scanned laser beam. In a second example of the system, optionally including the first example, the objective setup further including: a lens pair to focus the scanned laser beam on the objective lens. In a third example of the system, optionally including one or both of the first and second examples, the objective setup further including: a second lens pair to focus the fluorescence emission to the 2D descanner. In a fourth example of the system, optionally including one or more or each of the first through third examples, the objective setup further including: a third lens pair comprising a first lens positioned on a first side of the adjustable pinhole and a second lens positioned on a second side of the adjustable pinhole opposite to the first side. In a fifth example of the system, optionally including one or more or each of the first through fourth examples, the objective setup further including: a tube lens to focus the rescanned fluorescence emission onto the detector, the tube lens being positioned between the two-dimensional rescanner and the detector. In a sixth example of the system, optionally including one or more or each of the first through fifth examples, the detector comprises a camera. In a seventh example of the system, optionally including one or more or each of the first through sixth examples, the objective lens collects the fluorescence emission in epi-mode. In an eighth example of the system, optionally including one or more or each of the first through seventh examples, the sample is illuminated volumetrically by the scanned single laser beam. In a ninth example of the system, optionally including one or more or each of the first through eighth examples, the system further comprises: a second objective setup including: a second 2D excitation scanner to provide a second scanned laser beam, a second objective lens to introduce the second scanned laser beam to a sample and to collect a second fluorescence emission from the sample, a second 2D descanner to descan the second fluorescence emission, a second adjustable pinhole to remove out-of-focus emissions from the descanned second fluorescence emission, a second 2D rescanner to rescan the descanned second fluorescence emission that passes through the second adjustable pinhole, and a second detector to receive the rescanned second fluorescence emission, and a third objective setup including: a third 2D excitation scanner to provide a third scanned laser beam, a third objective lens to introduce the third scanned laser beam to a sample and to collect a third fluorescence emission from the sample, a third 2D descanner to descan the third fluorescence emission, a third adjustable pinhole to remove out-of-focus emissions from the descanned third fluorescence emission, a third 2D rescanner to rescan the descanned third fluorescence emission that passes through the third adjustable pinhole, and a third detector to receive the rescanned third fluorescence emission, and one or more processors in operative communication with the detector, the second detector, and the third detector to generate the image based upon at least the rescanned fluorescence emission, the rescanned second fluorescence emission, and the rescanned third fluorescence emission.

In another representation, the disclosure also provides support for a method of multiview super-resolution microscopy comprising: providing a scanned laser beam, introducing the scanned laser beam to a sample through an objective lens, collecting fluorescence emission from the sample through the objective lens, descanning the fluorescence emission, removing out-of-focus fluorescence emissions from the descanned fluorescence emission, rescanning the descanned fluorescence emission from which out-of-focus emissions have been removed, and generating an image based upon at least the rescanned fluorescence emission. In a first example of the method, the method further comprises: separating the fluorescence emission from the scanned laser beam with a dichroic mirror. In a second example of the method, optionally including the first example, the detector comprises a camera. In a third example of the method, optionally including one or both of the first and second examples, the objective lens collects the fluorescence emission in epi-mode. In a fourth example of the method, optionally including one or more or each of the first through third examples, the sample is illuminated volumetrically by the scanned single laser beam.

In another representation, the disclosure also provides support for a method comprising: providing a first microscopy image derived from sharp structured illumination to a neural network at each of a plurality of angles of rotation, generating, for each of the plurality of angles of rotation, a respectively-corresponding second microscopy image based upon the first microscopy image and super-resolved in a single dimension along an axis set by the angle of rotation, and combining the plurality of second microscopy images into a third microscopy image, wherein the third microscopy image is super-resolved in a plurality of directions respectively corresponding with plurality of angles of rotation. In a first example of the method, the neural network is trained based on pairs of images each of which include a microscopy image derived from sharp structured illumination that is non-super-resolved and a corresponding second microscopy image that is super-resolved in a single dimension. In a second example of the method, optionally including the first example, the plurality of angles of rotation includes at least four angles. In a third example of the method, optionally including one or both of the first and second examples, the plurality of angles of rotation includes at least six angles. In a fourth example of the method, optionally including one or more or each of the first through third examples, the angles of rotation are spaced by a substantially uniform increment. In a fifth example of the method, optionally including one or more or each of the first through fourth examples, the plurality of second microscopy images are combined into the third microscopy image by joint deconvolution. In a sixth example of the method, optionally including one or more or each of the first through fifth examples, the first microscopy image is a diffraction-limited confocal microscopy image.

In another representation, the disclosure also provides support for a method of producing a super-resolution microscopy image with isotropic resolution, comprising: providing a microscopy image derived from sharp structured illumination to a neural network at each of a plurality of rotations, generating a plurality of single-dimension enhanced-resolution microscopy images respectively corresponding with the plurality of rotations, and combining the plurality of single-dimension enhanced-resolution microscopy images by joint deconvolution into the super-resolved microscopy image with isotropic resolution. In a first example of the method, the neural network is trained based on pairs of images each of which include a first microscopy image derived from sharp structured illumination that is not super-resolved in any dimension and a corresponding second microscopy image that is super-resolved in a single dimension. In a second example of the method, optionally including the first example, the plurality of rotations are at angles of pi radians divided by an integer greater than or equal to four. In a third example of the method, optionally including one or both of the first and second examples, the plurality of rotations are at angles of pi radians divided by an integer greater than or equal to six.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A multiview super resolution microscopy system comprising:
a first objective setup including:
a first illumination generator to provide a first selectively-blanked illumination line scan;
a first objective lens to introduce the first selectively-blanked illumination line scan to a sample and to collect a first fluorescence emission from the sample, the first objective lens being oriented along a first directional axis; and
a first detector to receive the first fluorescence emission from the first objective lens; and
a second objective setup including:
a second illumination generator to provide a second selectively-blanked illumination line scan;
a second objective lens to introduce the second selectively-blanked illumination line scan to the sample and to collect a second fluorescence emission from the sample, the second objective lens being oriented along a second directional axis oblique to the first directional axis; and
a second detector to receive the second fluorescence emission from the second objective lens; and
one or more processors in operative communication with the first detector and the second detector for combining at least the first fluorescence emission and the second fluorescence emission to generate a composite image.

2. The multiview super resolution microscopy system of claim 1, wherein the first objective lens is positioned below the sample; and
wherein the second objective lens is positioned above the sample.

3. The multiview super resolution microscopy system of claim 1, wherein the first objective setup further includes:
a first light source to transmit a first laser beam; and
a first fast shutter in operative association with the first illumination generator to collectively blank the first laser beam to produce the first selectively-blanked illumination line scan; and
wherein the second objective setup further includes:
a second light source to transmit a second laser beam; and
a second fast shutter in operative association with the second illumination generator to collectively blank the second laser beam to produce the second selectively-blanked illumination line scan.

4. The multiview super resolution microscopy system of claim 3, wherein at least one of the first fast shutter and the second fast shutter includes one of: an acousto-optic tunable filter; a fast polarization sensitive shutter; a fast shutter provided within a head of the respective light source; and a fast mechanical shutter.

5. The multiview super resolution microscopy system of claim 1, wherein the first objective setup further includes:
a first dichroic mirror in communication with the first objective lens to separate the first selectively-blanked illumination line scan from the first fluorescence emission; and
wherein the second objective setup further includes:
a second dichroic mirror in communication with the second objective lens to separate the second selectively-blanked illumination line scan from the second fluorescence emission.

6. The multiview super resolution microscopy system of claim 1, wherein the first selectively-blanked illumination line scan is blanked at a first phase shift; and
wherein the second selectively-blanked illumination line scan is blanked at a second phase shift different from the first phase shift.

7. The multiview super resolution microscopy system of claim 1, wherein the first objective lens collects the first fluorescence emission in epi-mode; and
wherein the second objective lens collects the second fluorescence emission in epi-mode.

8. The multiview super resolution microscopy system of claim 1, wherein the first detector is operable in a mode to filter out out-of-focus portions of the first fluorescence emission; and
wherein the second detector is operable in a mode to filter out out-of-focus portions of the second fluorescence emission.

9. The multiview super resolution microscopy system of claim 1, further comprising:
a third objective setup including:
a third illumination generator to provide a third selectively-blanked illumination line scan;
a third objective lens to introduce the third selectively-blanked illumination line scan to the sample and to collect a third fluorescence emission from the sample, the third objective lens being oriented along a third directional axis oblique to the first directional axis and different from the second directional axis; and
a third detector to receive the third fluorescence emission from the third objective lens,
wherein the one or more processors are in operative communication with the first detector, the second detector, and the third detector for combining at least the first fluorescence emission, the second fluorescence emission, and the third fluorescence emission to generate the composite image.

10. The multiview super resolution microscopy system of claim 9, wherein the third directional axis is substantially orthogonal to the second directional axis.

11. The multiview super resolution microscopy system of claim 10, wherein the first objective lens is positioned below the sample; and
wherein the second objective lens and the third objective lens are positioned above the sample.

12. A method of multiview super-resolution microscopy comprising:
providing a first selectively-blanked illumination line scan;
providing a second selectively-blanked illumination line scan;
introducing the first selectively-blanked illumination line scan to a sample through a first objective lens, the first objective lens being oriented toward the sample from a first direction;
introducing the second selectively-blanked illumination line scan to the sample through a second objective lens, the second objective lens being oriented to the sample from a second direction at an obtuse angle to the first direction;
collecting a first fluorescence emission from the sample through the first objective lens;
collecting a second fluorescence emission from the sample through the second objective lens;
receiving the first fluorescence emission at a first detector;
receiving the second fluorescence emission at a second detector; and
combining at least the first fluorescence emission and the second fluorescence emission to generate a composite image.

13. The method of multiview super-resolution microscopy of claim 12, further comprising:
transmitting a first laser beam;
transmitting a second laser beam;
blanking the first laser beam with a first fast shutter in operative association with a first illumination generator to produce the first selectively-blanked illumination line scan; and
blanking the second laser beam with a second fast shutter in operative association with a second illumination generator to produce the second selectively-blanked illumination line scan.

14. The method of multiview super-resolution microscopy of claim 13, wherein at least one of the first fast shutter and the second fast shutter includes one of: an acousto-optic tunable filter; a fast polarization sensitive shutter; a fast shutter provided within a head of the respective light source; and a fast mechanical shutter.

15. The method of multiview super-resolution microscopy of claim 12, further comprising:
separating the first selectively-blanked illumination line scan from the first fluorescence emission with a first dichroic mirror; and
separating the second selectively-blanked illumination line scan from the second fluorescence emission with a second dichroic mirror.

16. The method of multiview super-resolution microscopy of claim 12, wherein a blanking of the first selectively-blanked illumination line scan is at a first phase shift; and
wherein a blanking of the second selectively-blanked illumination line scan is at a second phase shift different from the first phase shift.

17. The method of multiview super-resolution microscopy of claim 12, wherein the first fluorescence emission and the second fluorescence emission are collected in epi-mode.

18. The method of multiview super-resolution microscopy of claim 12, further comprising:
filtering out out-of-focus portions of the first fluorescence emission; and
filtering out out-of-focus portions of the second fluorescence emission.

19. The method of multiview super-resolution microscopy of claim 12, further comprising:
providing a third selectively-blanked illumination line scan;
introducing the third selectively-blanked illumination line scan to the sample through a third objective lens, the third objective lens being oriented to the sample from a third direction at an obtuse angle to the first direction, and the third direction being different than the second direction;
collecting a third fluorescence emission from the sample through the third objective lens;
receiving the third fluorescence emission at a third detector; and
combining at least the first fluorescence emission, the second fluorescence emission, and the third fluorescence emission to generate the composite image.

20. The method of multiview super-resolution microscopy of claim 19, wherein the third direction is oriented at a substantially right angle to the second direction.

21. A multiview super resolution microscopy system comprising:
an objective setup including:
a two-dimensional (2D) excitation scanner to provide a scanned laser beam;
an objective lens to introduce the scanned laser beam to a sample and to collect a fluorescence emission from the sample;
a 2D descanner to descan the fluorescence emission;
an adjustable pinhole to remove out-of-focus emissions from the descanned fluorescence emission;
a 2D rescanner to rescan the descanned fluorescence emission that passes through the adjustable pinhole; and
a detector to receive the rescanned fluorescence emission; and
one or more processors in operative communication with the detector to generate an image based upon at least the rescanned fluorescence emission.

22. The multiview super resolution microscopy system of claim 21, the objective setup further including:
a dichroic mirror to separate the fluorescence emission from the scanned laser beam.

23. The multiview super resolution microscopy system of claim 21, the objective setup further including:
a lens pair to focus the scanned laser beam on the objective lens.

24. The multiview super resolution microscopy system of claim 23, the objective setup further including:
a second lens pair to focus the fluorescence emission to the 2D descanner.

25. The multiview super resolution microscopy system of claim 24, the objective setup further including:
a third lens pair comprising a first lens positioned on a first side of the adjustable pinhole and a second lens positioned on a second side of the adjustable pinhole opposite to the first side.

26. The multiview super resolution microscopy system of claim 21, the objective setup further including:
a tube lens to focus the rescanned fluorescence emission onto the detector, the tube lens being positioned between the 2D rescanner and the detector.

27. The multiview super resolution microscopy system of claim 21, wherein the detector comprises a camera.

28. The multiview super resolution microscopy system of claim 21, wherein the objective lens collects the fluorescence emission in epi-mode.

29. The multiview super resolution microscopy system of claim 21, wherein the sample is illuminated volumetrically by the scanned laser beam.

30. The multiview super resolution microscopy system of claim 21, further comprising:
a second objective setup including:
a second 2D excitation scanner to provide a second scanned laser beam;
a second objective lens to introduce the second scanned laser beam to the sample and to collect a second fluorescence emission from the sample;
a second 2D descanner to descan the second fluorescence emission;
a second adjustable pinhole to remove out-of-focus emissions from the descanned second fluorescence emission;
a second 2D rescanner to rescan the descanned second fluorescence emission that passes through the second adjustable pinhole; and
a second detector to receive the rescanned second fluorescence emission; and
a third objective setup including:
a third 2D excitation scanner to provide a third scanned laser beam;
a third objective lens to introduce the third scanned laser beam to the sample and to collect a third fluorescence emission from the sample;
a third 2D descanner to descan the third fluorescence emission;
a third adjustable pinhole to remove out-of-focus emissions from the descanned third fluorescence emission;
a third 2D rescanner to rescan the descanned third fluorescence emission that passes through the third adjustable pinhole; and
a third detector to receive the rescanned third fluorescence emission; and
one or more processors in operative communication with the detector, the second detector, and the third detector to generate the image based upon at least the rescanned fluorescence emission, the rescanned second fluorescence emission, and the rescanned third fluorescence emission.

31. A method of multiview super-resolution microscopy comprising:
providing a scanned laser beam;
introducing the scanned laser beam to a sample through an objective lens;
collecting fluorescence emission from the sample through the objective lens;
descanning the fluorescence emission;
removing out-of-focus fluorescence emissions from the descanned fluorescence emission;
rescanning the descanned fluorescence emission from which out-of-focus emissions have been removed; and
generating an image based upon at least the rescanned fluorescence emission.

32. The method of multiview super-resolution microscopy of claim 31, further comprising:
separating the fluorescence emission from the scanned laser beam with a dichroic mirror.

33. The method of multiview super-resolution microscopy of claim 31, wherein the image is based upon focusing the rescanned fluorescence emission onto a detector that comprises a camera.

34. The method of multiview super-resolution microscopy of claim 31, wherein the objective lens collects the fluorescence emission in epi-mode.

35. The method of multiview super-resolution microscopy of claim 31, wherein the sample is illuminated volumetrically by the scanned laser beam.

36. A method comprising:
providing a first microscopy image derived from sharp structured illumination to a neural network at each of a plurality of angles of rotation;
generating, for each of the plurality of angles of rotation, a respectively-corresponding second microscopy image based upon the first microscopy image and super-resolved in a single dimension along an axis set by the angle of rotation; and
combining the plurality of second microscopy images into a third microscopy image,
wherein the third microscopy image is super-resolved in a plurality of directions respectively corresponding with plurality of angles of rotation.

37. The method of claim 36, wherein the neural network is trained based on pairs of images each of which include a microscopy image derived from sharp structured illumination that is non-super-resolved and a corresponding second microscopy image that is super-resolved in the single dimension.

38. The method of claim 36, wherein the plurality of angles of rotation includes at least four angles.

39. The method of claim 36, wherein the plurality of angles of rotation includes at least six angles.

40. The method of claim 36, wherein the angles of rotation are spaced by a substantially uniform increment.

41. The method of claim 36, wherein the plurality of second microscopy images are combined into the third microscopy image by joint deconvolution.

42. The method of claim 36, wherein the first microscopy image is a diffraction-limited confocal microscopy image.

43. A method of producing a super-resolution microscopy image with isotropic resolution, comprising:
providing a microscopy image derived from sharp structured illumination to a neural network at each of a plurality of rotations;
generating a plurality of single-dimension enhanced-resolution microscopy images respectively corresponding with the plurality of rotations; and
combining the plurality of single-dimension enhanced-resolution microscopy images by joint deconvolution into the super resolution microscopy image with isotropic resolution.

44. The method of producing the super-resolution microscopy image with isotropic resolution of claim 43, wherein the neural network is trained based on pairs of images each of which include a first microscopy image derived from sharp structured illumination that is not super-resolved in any dimension and a corresponding second microscopy image that is super-resolved in a single dimension.

45. The method of producing the super-resolution microscopy image with isotropic resolution of claim 43, wherein the plurality of rotations are at angles of pi radians divided by an integer greater than or equal to four.

46. The method of producing the super-resolution microscopy image with isotropic resolution of claim 43, wherein the plurality of rotations are at angles of pi radians divided by an integer greater than or equal to six.
